(19) United States
(12) Patent Application Publication
(10) Pub. No.: US 2017/0108391 A1
(43) Pub. Date: Apr. 20, 2017

(54) SENSOR

(71) Applicant: KABUSHIKI KAISHA TOSHIBA, Tokyo (JP)

(72) Inventors: Tamio IKEHASHI, Yokohama (JP); Tomohiro SAITO, Yokohama (JP); Ryunosuke GANDO, Yokohama (JP); Etsuji OGAWA, Kawasaki (JP)

(73) Assignee: KABUSHIKI KAISHA TOSHIBA, Tokyo (JP)

(21) Appl. No.: 15/069,216

(22) Filed: Mar. 14, 2016

(30) Foreign Application Priority Data
Oct. 16, 2015 (JP) 2015-204777

(51) Int. Cl. G01L 9/00; G01L 9/12

(52) U.S. Cl. CPC G01L 9/0072; G01L 9/12; G01L 9/0042

(57) ABSTRACT

According to one embodiment, a sensor includes a substrate, a variable capacitor including a bottom electrode provided on the substrate and a top electrode provided above the bottom electrode so as to face the bottom electrode, a movable structure including a portion located above the top electrode and being movable in accordance with a specific physical quantity, a support structure including at least one support portion supporting the top electrode, and a connection structure connecting the movable structure and the top electrode to displace the top electrode based on displacement of the movable structure, wherein the top electrode is displaced about an axis penetrating the at least one support portion, which serves as a first rotation axis.

### CROSS-REFERENCE TO RELATED APPLICATIONS

This application is based upon and claims the benefit of priority from Japanese Patent Application No. 2015-204777, filed Oct. 16, 2015, the entire contents of which are incorporated herein by reference.

### FIELD

Embodiments described herein relate generally to a sensor.

### BACKGROUND

As a sensor adopting a technology of micro-electromechanical systems (MEMS), for example, a pressure sensor is well known.

In the pressure sensor, generally, a variable capacitor is composed of a bottom electrode (fixed electrode) and a top electrode (movable electrode), and is covered with a thin-film structure for pressure detection, which is connected to the top electrode. As the thin-film structure is displaced in accordance with the variation of pressure, a distance between the bottom electrode and the top electrode is varied and the capacitance of the variable capacitor is also varied. The pressure can be therefore detected by detecting the capacitance of the variable capacitor. In the pressure sensor, however, the variation of the capacitance has not been considered sufficient and the pressure sensor having a high detection accuracy has been difficult to obtain.

A sensor having a high detection accuracy is therefore desired.

### BRIEF DESCRIPTION OF THE DRAWINGS

FIG. 1 is an explanatory cross-sectional view showing a basic concept of a sensor (pressure sensor) of a first embodiment.

FIG. 2 is an electric circuit diagram showing a configuration of a sense circuit to obtain differential capacitance in the sensor of the first embodiment.

FIG. 3 is an illustration pictorially showing a first basic configuration example of the sensor of the first embodiment.

FIG. 4 is an illustration pictorially showing a second basic configuration example of the sensor of the first embodiment.

FIG. 5 is a cross-sectional view pictorially showing a configuration in which the sensor of the first embodiment is formed on a semiconductor substrate.

FIG. 6 is a cross-sectional view pictorially showing in part a method of manufacturing the sensor of the first embodiment.

FIG. 7 is a cross-sectional view pictorially showing in part the method of manufacturing the sensor of the first embodiment.

FIG. 8 is a cross-sectional view pictorially showing in part the method of manufacturing the sensor of the first embodiment.

FIG. 9 is a cross-sectional view pictorially showing in part the method of manufacturing the sensor of the first embodiment.

FIG. 10 is a cross-sectional view pictorially showing in part the method of manufacturing the sensor of the first embodiment.

FIG. 11 is a cross-sectional view pictorially showing in part the method of manufacturing the sensor of the first embodiment.

FIG. 12 is an illustration pictorially showing the configuration of the sensor in the second basic configuration example of the first embodiment.

FIG. 13 is an illustration pictorially showing a configuration of a first modified example of the sensor of the first embodiment.

FIG. 14 is an illustration showing dimensions of members to obtain a value of dΔC/dZ in the first embodiment.

FIG. 15 is a graph showing the value of dΔC/dZ set when the dimensions of the members are varied, in the first embodiment.

FIG. 16 is an illustration pictorially showing a configuration of a second modified example of the sensor of the first embodiment.

FIG. 17 is an illustration pictorially showing a configuration of a third modified example of the sensor of the first embodiment.

FIG. 18 is an illustration showing an effect of the third modified example of the sensor of the first embodiment.

FIG. 19 is an illustration pictorially showing a configuration of a fourth modified example of the sensor of the first embodiment.

FIG. 20 is an illustration pictorially showing a first configuration example of a sensor (pressure sensor) of a second embodiment.

FIG. 21 is an illustration pictorially showing a second configuration example of the sensor of the second embodiment.

FIG. 22 is an illustration pictorially showing a third configuration example of the sensor of the second embodiment.

FIG. 23 is an illustration pictorially showing a fourth configuration example of the sensor of the second embodiment.

FIG. 24 is an illustration pictorially showing a fifth configuration example of the sensor of the second embodiment.

FIG. 25 is an illustration pictorially showing a sixth configuration example of the sensor of the second embodiment.

FIG. 26 is an illustration pictorially showing a seventh configuration example of the sensor of the second embodiment.

FIG. 27 is an illustration pictorially showing an eighth configuration example of the sensor of the second embodiment.

FIG. 28 is an illustration pictorially showing a ninth configuration example of the sensor of the second embodiment.

FIG. 29 is an illustration pictorially showing a first configuration example of a sensor (pressure sensor) of a third embodiment.

FIG. 30 is an illustration pictorially showing a second configuration example of the sensor of the third embodiment.

FIG. 31 is an illustration pictorially showing a third configuration example of the sensor of the third embodiment.

FIG. 32 is an illustration pictorially showing a fourth configuration example of the sensor of the third embodiment.

FIG. 33 is an illustration pictorially showing a first configuration example of a sensor (pressure sensor) of a fourth embodiment.

FIG. 34 is an illustration pictorially showing a second configuration example of the sensor of the fourth embodiment.

FIG. 35 is an illustration pictorially showing a third configuration example of the sensor of the fourth embodiment.

FIG. 36 is a graph showing an effect of the sensor (pressure) of the first to fourth embodiments.

FIG. 37 is an illustration pictorially showing a configuration example in which the sensor (pressure sensor) of the first to fourth embodiments is disposed in a chip.

FIG. 38 is an illustration pictorially showing another configuration example in which the sensor (pressure sensor) of the first to fourth embodiments is disposed in a chip.

FIG. 39 pictorially shows a configuration example of an accelerometer using the same principle as the sensor (pressure sensor) of the first to fourth embodiments.

### DETAILED DESCRIPTION

In general, according to one embodiment, a sensor includes: a substrate; a variable capacitor including a bottom electrode provided on the substrate and a top electrode provided above the bottom electrode so as to face the bottom electrode; a movable structure including a portion located above the top electrode and being displaceable in accordance with a specific physical quantity; a support structure including at least one support portion supporting the top electrode; and a connection structure connecting the movable structure and the top electrode to displace the top electrode based on displacement of the movable structure, wherein the top electrode is displaced about an axis penetrating the at least one support portion, which serves as a first rotation axis.

Embodiments will be described hereinafter with reference to the accompanying drawings.

### Embodiment 1

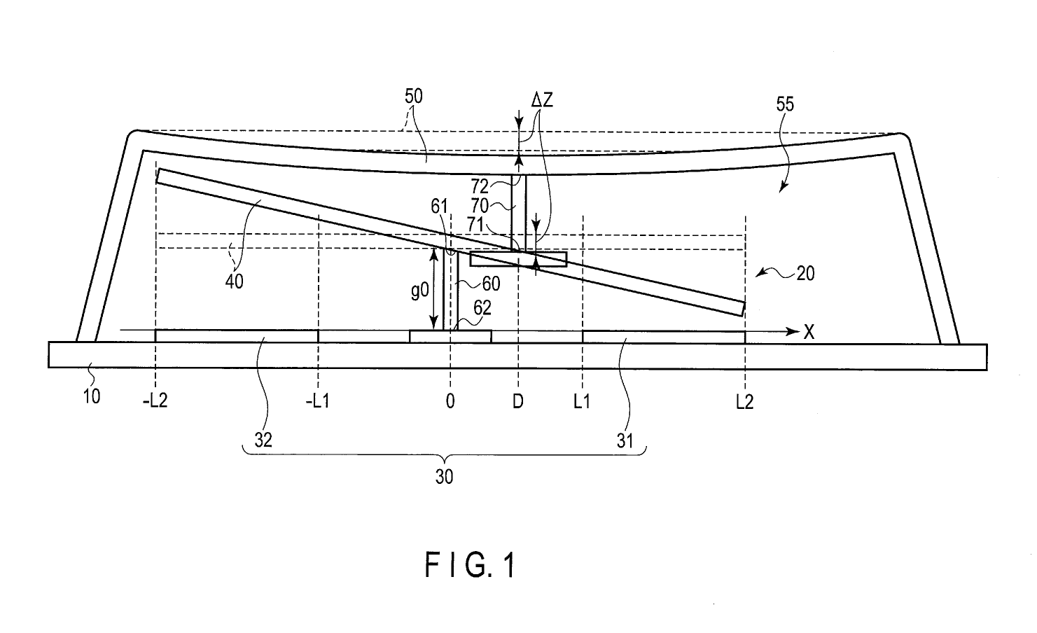

FIG. 1 is an explanatory cross-sectional view showing a basic concept of a sensor of a first embodiment. The sensor of the present embodiment is used as a pressure sensor and is formed with the technology of micro-electromechanical systems (MEMS).

The sensor (pressure sensor) shown in FIG. 1 comprises a substrate 10, a variable capacitor 20 including a bottom electrode 30 and a top electrode 40, a movable structure 50, a support structure 60, and a connection structure 70.

As explained later, a semiconductor substrate, a transistor, an interconnect, an insulation area and the like are used in the substrate 10.

The variable capacitor 20 includes the bottom electrode 30 provided on the substrate 10 and the top electrode 40 which is provided above the bottom electrode 30 and faces the bottom electrode 30. The bottom electrode 30 includes a first electrode portion 31 and a second electrode portion 32 electrically insulated from each other.

The movable structure 50 includes a portion located above the top electrode 40 and can be displaced in accordance with a specific physical quantity. In the present embodiment, the movable structure 50 is constituted by a thin-film structure (thin-film dome) covering the variable capacitor 20 and hermetically seals the variable capacitor 20. A cavity 55 is formed inside the movable structure (thin-film structure) 50. The specific physical quantity is the pressure applied to the movable structure (thin-film structure) 50. The thin-film structure 50 is displaced in accordance with the pressure applied from the outside of the thin-film structure 50 since the interior (cavity 55) of the thin-film structure 50 is isolated from the outside of the thin-film structure 50 by the thin-film structure 50.

The top electrode 40 is supported by the support structure 60. More specifically, the support structure 60 includes at least one support portion 61 supporting the top electrode 40, and at least one fixed portion 62 fixed to the substrate 10.

The movable structure (thin-film structure) 50 and the top electrode 40 are connected to each other by the connection structure 70. The connection structure 70 is provided to displace the top electrode 40 based on the displacement of the movable structure (thin-film structure) 50. In other words, when the thin-film structure 50 is displaced by the pressure from the outside, the top electrode 40 is displaced via the connection structure 70. The connection structure 70 includes at least one connection portion 71 connected to the top electrode 40 and a fixed portion 72 fixed to the movable structure (thin-film structure) 50. The connection structure 70 is disposed between the support structure 60 and a first capacitor to be explained later.

The at least one connection portion 71 is deviated from the at least one support portion 61 as viewed from a direction perpendicular to the main surface of the top electrode 40. The portion supported by at least one support portion 61 of the top electrode 40 is fixed by the at least one support portion 61, and is not displaced when the top electrode 40 is displaced. In other words, the top electrode 40 is displaced about an axis penetrating the at least one support portion 61, which serves as a rotation axis (fixed axis). Thus, if the thin-film structure 50 is displaced, a portion located on one of the sides of the top electrode 40 and a portion located on the other side are displaced in directions opposite to each other, with respect to the axis penetrating the at least one support portion 61, on the principle of leverage. In other words, as shown in FIG. 1, when the top electrode 40 is displaced by the downward displacement of the thin-film structure 50 and the connection structure 70, a first capacitance between the top electrode 40 and the first electrode portion 31 is increased while a second capacitance between the top electrode 40 and the second electrode portion 32 is decreased. Therefore, a differential capacitance of the first capacitance and the second capacitance can be obtained by providing the first electrode portion 31 and second electrode portion 32, which are electrically insulated from each other, as the bottom electrode 30. The pressure can be detected based on the differential capacitance.

The axis penetrating the at least one support portion 61 (i.e., the rotation axis perpendicular to the surface of a sheet of drawing) penetrates a central portion of the top electrode 40 as view from the direction perpendicular to the main surface of the top electrode 40. The fixed portion 72 of the connection structure 70 is fixed at the central portion of the thin-film structure 50.

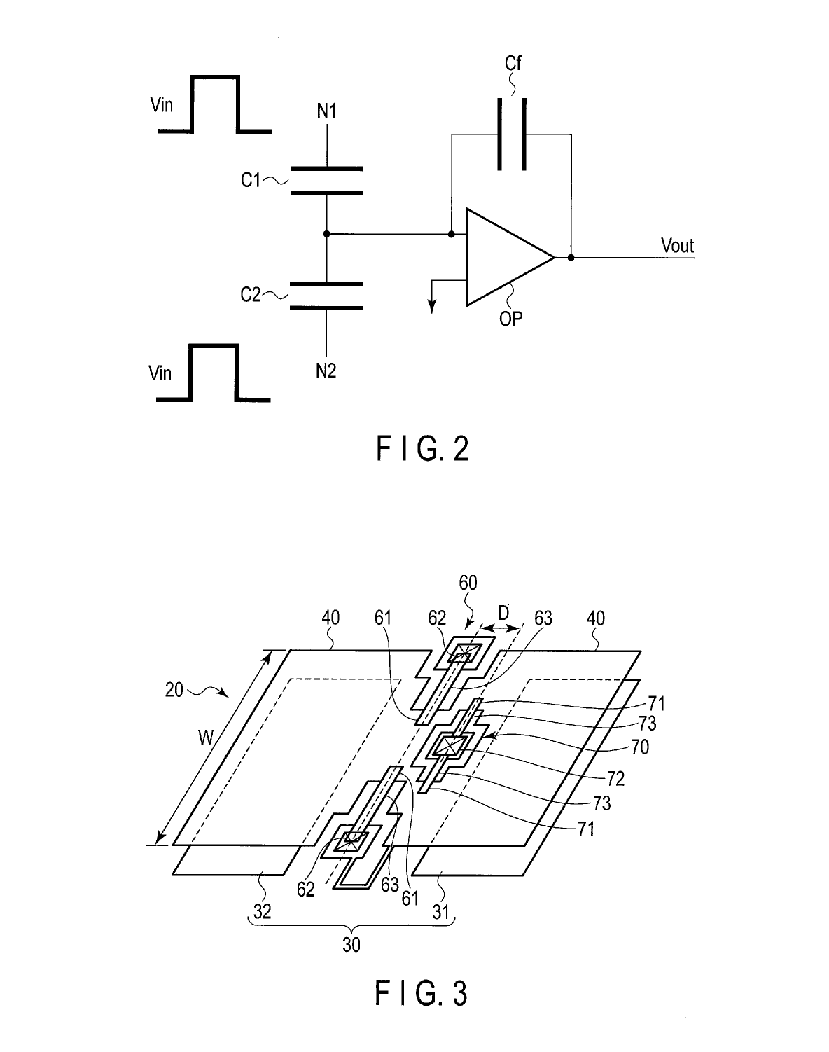

FIG. 2 is an electric circuit diagram showing a configuration of the sense circuit to obtain the above-explained differential capacitance.

C1 indicates a first capacitor composed of the top electrode 40 and the first electrode portion 31 and C2 indicates a second capacitor composed of the top electrode 40 and the second electrode portion 32. The first capacitor C1 and the second capacitor C2 are located between a node N1 and N2 and serially connected to each other, and a junction between the first capacitor C1 and the second capacitor C2 is connected to an input terminal of an operational amplifier OP. A capacitor Cf is connected between the input terminal and an output terminal of the operational amplifier OP.

The differential capacitance will be explained below in detail.

As shown in FIG. 1, a height of the support structure 60 is represented by g0. The support portion 61 of the support structure 60 is assumed to be an origin and a direction parallel to the substrate 10 is assumed to be an x-axis direction. A position coordinate of one of ends of the first electrode 31 is represented by L1 and a position coordinate of the other end of the first electrode 31 is represented by L2. A position coordinate of one of ends of the second electrode 32 is represented by −L1 and a position coordinate of the other end of the second electrode 32 is represented by −L2. Furthermore, a position coordinate of the connection portion 71 of the connection structure 70 is represented by D.

When a displacement amount of the movable structure (thin-film structure) 50 (i.e., the displacement amount of the top electrode 40) is represented by Δz, a first capacitance C₊(Δz) of the first capacitor C1 and a second capacitance C₋(Δz) of the second capacitor C2 are represented by:

$${C}_{+} ( Δ z ) = {\int }_{L 1}^{L 2} \frac{sW d x}{g0 - ax} = \frac{sW}{a} ln \frac{g0 - aL 1}{g0 - aL 2}$$

$${C}_{-} ( Δ z ) = {\int }_{L 1}^{L 2} \frac{sW d x}{g0 + ax} = \frac{sW}{a} ln \frac{g0 - aL 2}{g0 - aL 1}$$

where a is equal to Δz/D.

At this time,

ΔC=C₊(Δz)−C₋(Δz)=2C_{L}r_{L}(Δz/g0)+0(a²),

where

C_{L}=εW(L2−L1)/g0,

r_{L}=(L1+L2)/2D.

In this example, r_{L} represents a leverage ratio, i.e., an amplification factor on the principle of leverage. W represents a width of the electrode (i.e., a width in a direction perpendicular to the x-axis).

In the sense circuit shown in FIG. 2,

Vout=(ΔC/Cf)Vin.

In contrast, in the conventional pressure sensor in which the top electrode (movable electrode) is moved up and down with respect to the bottom electrode (fixed electrode),

ΔCᵢₙᵥT=Cₛₑₙ−C_{ref}=C₀(Δz/g0)

where Cₛₑₙ represents a capacitance of a sensing capacitor (variable capacitor), C_{ref} represents a capacitance of a reference capacitor, and C0 is equal to εSₑ/g0. Se represents an electrode area.

It is assumed here that

C0=2C_{L}

L1=100 mm

L2=200 μm

D=15 μm.

In this case, r_{L} is 10 in the configuration of the present embodiment. The sensitivity which is ten times as great as that in prior art can be therefore obtained.

As explained above, the sensor (pressure sensor) of the present embodiment uses the variable capacitor 20 using the principle of leverage. For this reason, the displacement of the top electrode 40 based on the displacement of the movable structure (thin-film structure) 50 can be increased. Thus, the sensitivity of detection can be increased, and a sensor having a high detection accuracy can be obtained.

In addition, in the present embodiment, the differential capacitance of the first capacitance and the second capacitance can be obtained by constituting the first capacitor having the first capacitance by both the top electrode 40 and the first electrode portion 31 of the bottom electrode 30, and constituting the second capacitor having the second capacitance by both the top electrode 40 and the second electrode portion 32. Consequently, the sensing property excellent in linearity can be acquired, and the sensor of a wide dynamic range can be obtained. The reference capacitor may not be provided by obtaining the differential capacitance of the first capacitance and the second capacitance. The device configuration can be therefore simplified.

Next, a basic configuration example of the sensor (pressure sensor) of the present embodiment will be explained in detail.

FIG. 3 is an illustration pictorially showing a first basic configuration example of the sensor (pressure sensor) of the present embodiment. Constituent elements corresponding to those shown in FIG. 1 are denoted by the same reference numerals as those shown in FIG. 1. The substrate 10 and the movable structure (thin-film structure) 50 shown in FIG. 1 are omitted in FIG. 3 for the purpose of simplifying the explanations but, actually, the substrate 10 and the movable structure (thin-film structure) 50 are provided.

In the present configuration example, the support structure 60 includes two support portions 61, two fixed portions 62 and two torsion bar members 63. Two support portions 61 are connected to the top electrode 40 and two fixed portions 62 function as anchors on the substrate 10. It should be noted that if the present configuration example is generalized, the support structure 60 includes at least one support portion 61, at least one fixed portion 62 and at least one torsion bar member 63 provided between the at least one support portion 61 and the at least one fixed portion 62.

In addition the connection structure 70 includes two connection portions 71, one fixed portion 72, and two torsion bar members 73. Two connection portions 71 are connected to the top electrode 40 and the fixed portion 72 functions as an anchor on the thin-film structure 50. It should be noted that if the present configuration example is generalized, the connection structure 70 includes the fixed portion 72, at least one connection portion 71, and at least one torsion bar member 73 provided between the fixed portion 72 and the at least one connection portion 71.

The torsion bar members 63 and 73 are arranged parallel to each other and displaced from each other. In other words, a first rotation axis penetrating the torsion bar members 63 and a second rotation axis penetrating the torsion bar members 73 are parallel to each other and displaced from each other. It should be noted that the rotation axis is an axis which is a center of rotation. The first rotation axis is a fixed axis, but the second rotation axis is displaced in accordance with displacement of the movable structure (thin-film structure) 50.

The torsion bar members 63 and 73 are formed of a brittle material. In the present configuration example, the torsion bar members 63 and 73 are formed of a material different from the material of the top electrode 40. The torsion bar members 63 and 73 may be formed of an insulating material or a conductive material. As the insulating material, SiN, SIC, AlO or the like can be used. As the conductive material, a material which hardly causes creep deformation is preferable, and TiAl, Si, SiGe or the like can be used. As regards Si, poly-Si or amorphous Si can be used.

As the material of the top electrode 40, an Al alloy (AlCu, TiAl or the like), Cu, Au, Si, SiGe or like can be used.

Thus, in the present configuration example, the top electrode 40 can be displaced (rotated) by handling the torsion bar members 63 as the rotation axis (fixed axis) since the support structure 60 includes the torsion bar member 63. The displacement operation (rotary operation) of the top electrode 40 can be therefore executed certainly (basic effect).

Moreover, in the present configuration example, options of the brittle material of the torsion bar members 63 can be increased since the torsion bar members 63 are formed of a material different from the material of the top electrode 40.

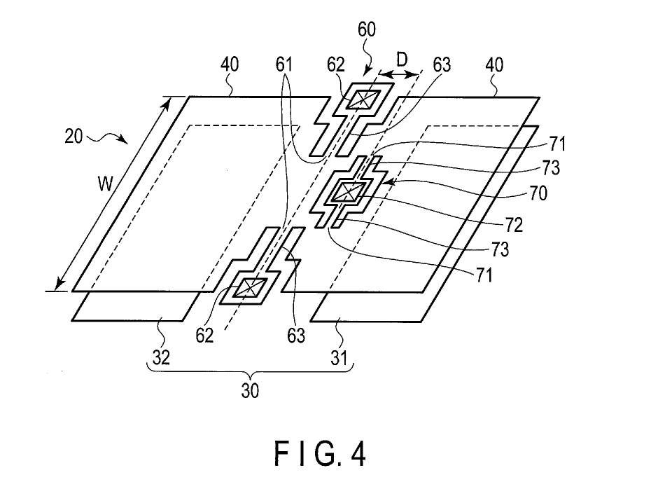

FIG. 4 is an illustration pictorially showing a second basic configuration example of the sensor (pressure sensor) of the present embodiment. Constituent elements corresponding to those shown in FIG. 1 and FIG. 3 are denoted by the same reference numerals as those shown in FIG. 1 and FIG. 3. The substrate 10 and the movable structure (thin-film structure) 50 shown in FIG. 1 are omitted in FIG. 4 for the purpose of simplifying the explanations but, actually, the substrate 10 and the movable structure (thin-film structure) 50 are provided.

The basic configuration of the present configuration example is the same as the first basic configuration example shown in FIG. 3. In other words, in the present configuration example, too, the support structure 60 includes the torsion bar members 63 formed of a brittle material. In the present configuration example, however, the torsion bar members 63 are formed of the same material as the material of the top electrode 40. Since the top electrode 40 is formed of a conductive material, the torsion bar members 63 are formed of a conductive material in the present configuration example. As the conductive material of the torsion bar members 63, a material which hardly causes creep deformation is preferable, and TiAl, Si, SiGe or the like can be used. As regards Si, poly-Si or amorphous Si can be used.

In the present configuration example, too, the same basic effect as that in the first basic configuration example can be obtained since the support structure 60 includes the torsion bar members 63. Moreover, in the present configuration example, the torsion bar members 63 and the top electrode 40 can be formed in the same process and the manufacturing process can be simplified since the torsion bar members 63 are formed of the same material as the material of the top electrode 40.

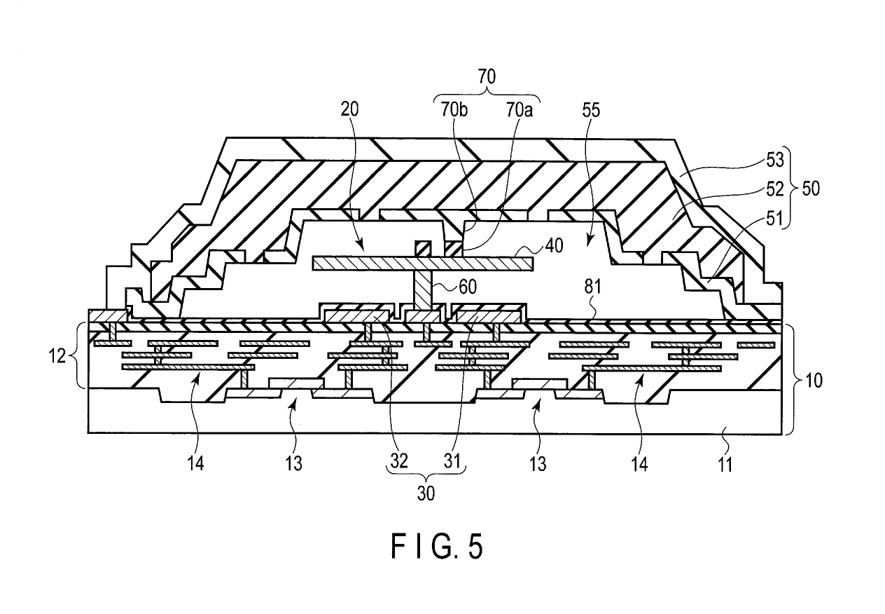

Next, a configuration example in which the sensor (pressure sensor) of the present embodiment is formed on the semiconductor substrate will be explained with reference to FIG. 5 (cross-sectional view). Constituent elements corresponding to those shown in FIG. 1 are denoted by the same reference numerals as those shown in FIG. 1.

The substrate 10 includes a semiconductor substrate 11, an insulating area 12 formed on the semiconductor substrate 11, a MOS transistor 13 provided in the surface area of the semiconductor substrate 11, and an interconnect 14 provided in the insulating area 12. A CMOS circuit is composed of the MOS transistor 13 and the interconnect 14.

A MEMS device is provided on the substrate 10. The MEMS device comprises the variable capacitor 20 including the bottom electrode 30 and the top electrode 40, the movable structure (thin-film structure) 50, the support structure 60, and the connection structure 70. The variable capacitor 20 is covered with the thin-film structure 50, and the cavity 55 is formed inside the thin-film structure 50. The thin-film structure 50 is formed by a first layer 51, a second layer 52 and a third layer 53. In addition, the bottom electrode 30 is covered with an insulating film 81.

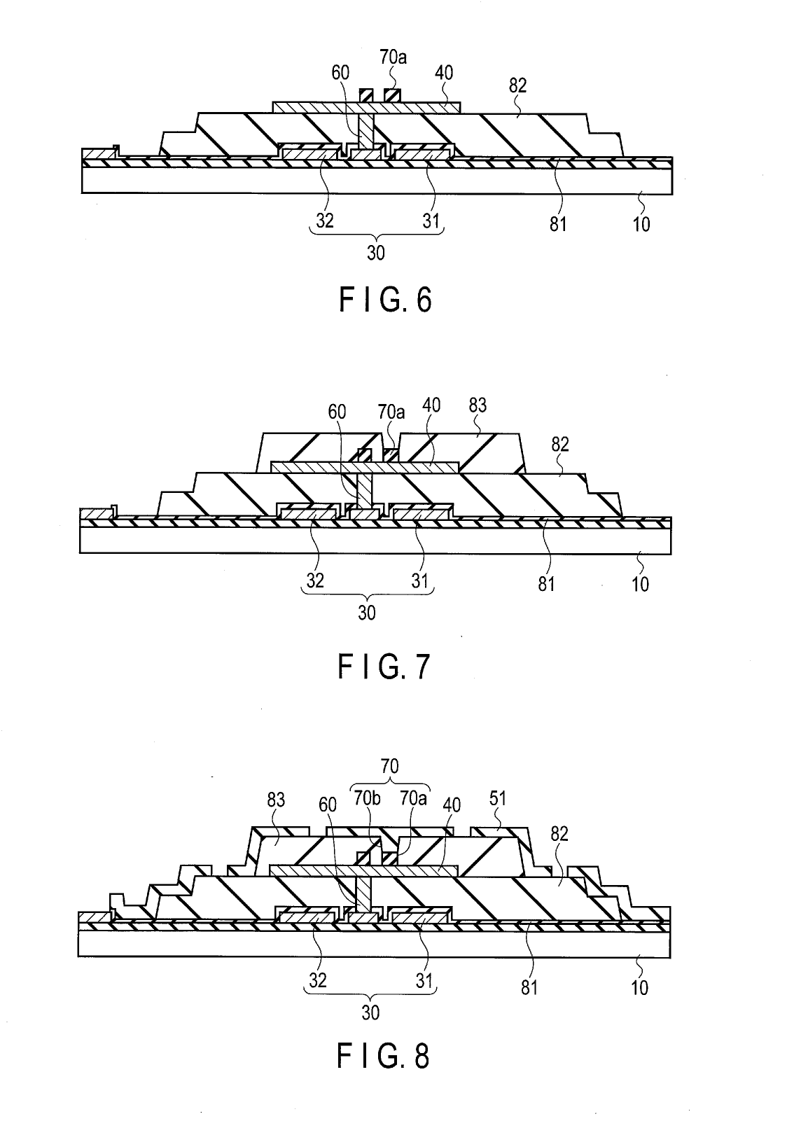

Next, a method of manufacturing the sensor (pressure sensor) of the present embodiment will be explained with reference to FIG. 6 to FIG. 11 (cross-sectional views). A method of manufacturing the sensor shown in FIG. 5 will be explained by way of example.

First, as shown in FIG. 6, the bottom electrode 30 including the first electrode portion 31 and the second electrode portion 32 is formed on the substrate 10. Next, an insulating film 81 is formed to cover the bottom electrode 30, and a sacrificial layer 82 is further formed on the insulating film 81. The sacrificial layer 82 is patterned and a hole for the support structure is formed in the sacrificial layer 82. After a conductive film such as a metal film is formed, the conductive film is patterned, and the top electrode 40 and the support structure 60 are formed. Furthermore, a material film (for example, SiN film) for the connection structure is formed, and a lower member 70a of the connection structure is formed by patterning the material film.

As shown in FIG. 7, a sacrificial film 83 is formed on the entire surface and then patterned.

As shown in FIG. 8, the first layer 51 of the thin-film structure 50 is formed on the entire surface. The first layer 51 is patterned and a hole is formed in the first layer 51 to remove the sacrificial layers 82 and 83. A part of the first layer 51 functions as an upper member 70b of the connection structure.

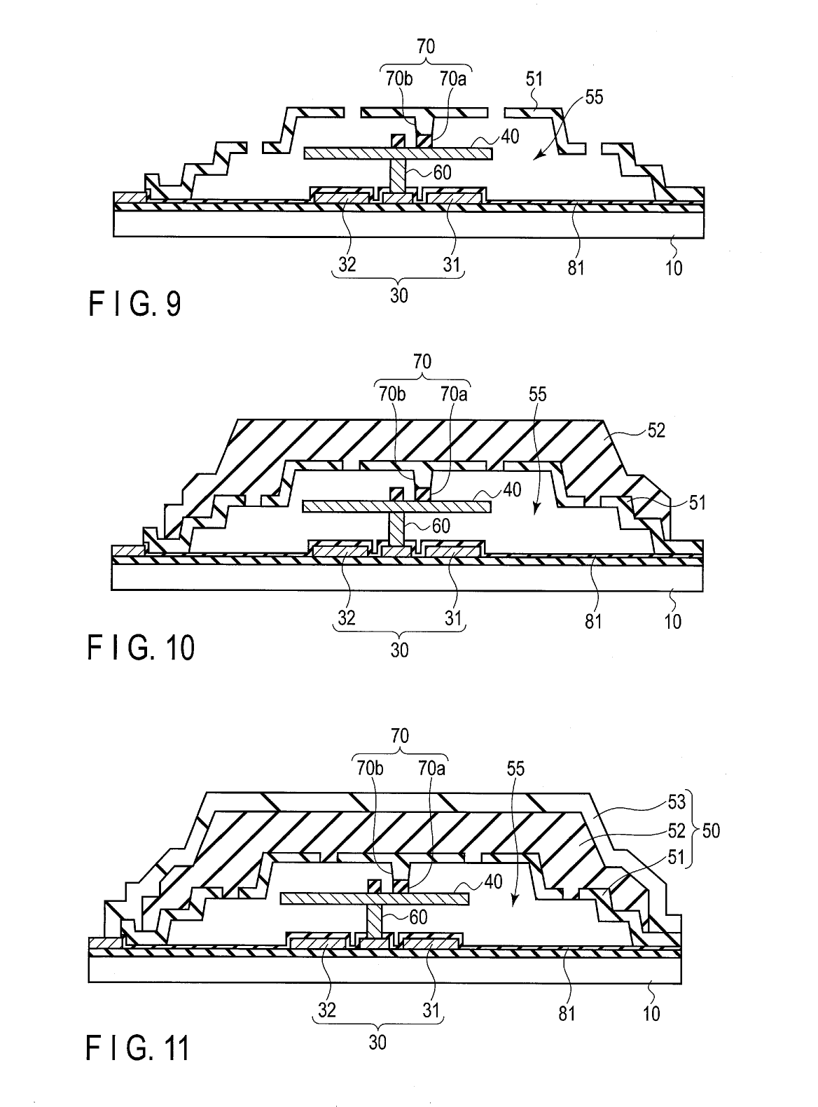

As shown in FIG. 9, a dry etching gas is supplied through the hole formed in the first layer 51 to remove the sacrificial layers 82 and 83. Consequently, the cavity 55 is formed inside the first layer 51. As shown in FIG. 10, the second layer 52 is formed on the first layer 51, and the hole in the first layer 51 is closed by the second layer 52.

As shown in FIG. 11, the third layer 53 is formed on the second layer 52. The thin-film structure 50 including the first layer 51, the second layer 52 and the third layer 53 is thereby formed. Consequently, the sensor shown in FIG. 5 can be formed.

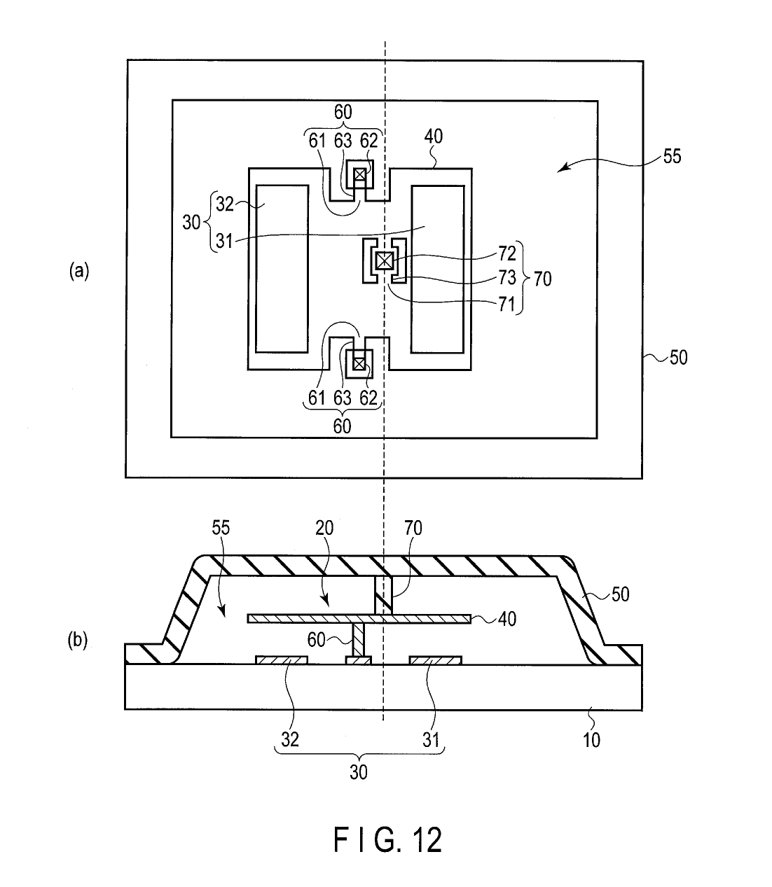

FIG. 12(a) is a plan view and FIG. 12(b) is a cross-sectional view both pictorially showing the configuration of the sensor (pressure sensor) in the second basic configuration example shown in FIG. 4. Since the basic elements have been explained with reference to FIG. 1, FIG. 4 and the like, constituent elements corresponding to those shown in FIG. 1 and FIG. 4 are denoted by the same reference numerals and the explanations on FIG. 12 are omitted. Thus, examples based on the configuration shown in FIG. 12 will be explained below with reference to the drawings. The elements explained below can also be applied to the first basic configuration example shown in FIG. 3.

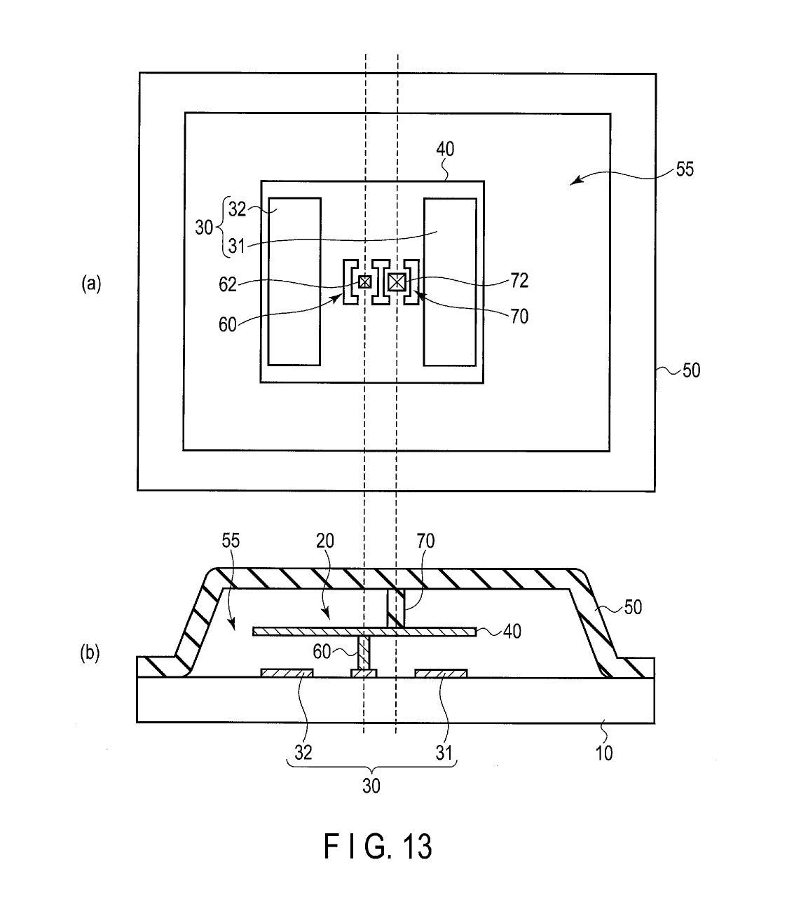

FIG. 13 pictorially shows a configuration of a first modified example of the sensor (pressure sensor) of the present embodiment.

In the basic configuration example shown in FIG. 12, two fixed portions 62 of the support structure 60 are provided in the area outside the top electrode 40. In the present modified example, however, one fixed portion 62 is provided to be close to the fixed portion 72 of the connection structure 70, in the central area surrounded by the top electrode 40. By adopting this configuration, a rate (dΔC/dZ) of the variation of differential capacitance ΔC to the displacement amount ΔZ of the thin-film structure 50 (i.e., the displacement amount of the top electrode 40) can be increased. This matter will be explained below.

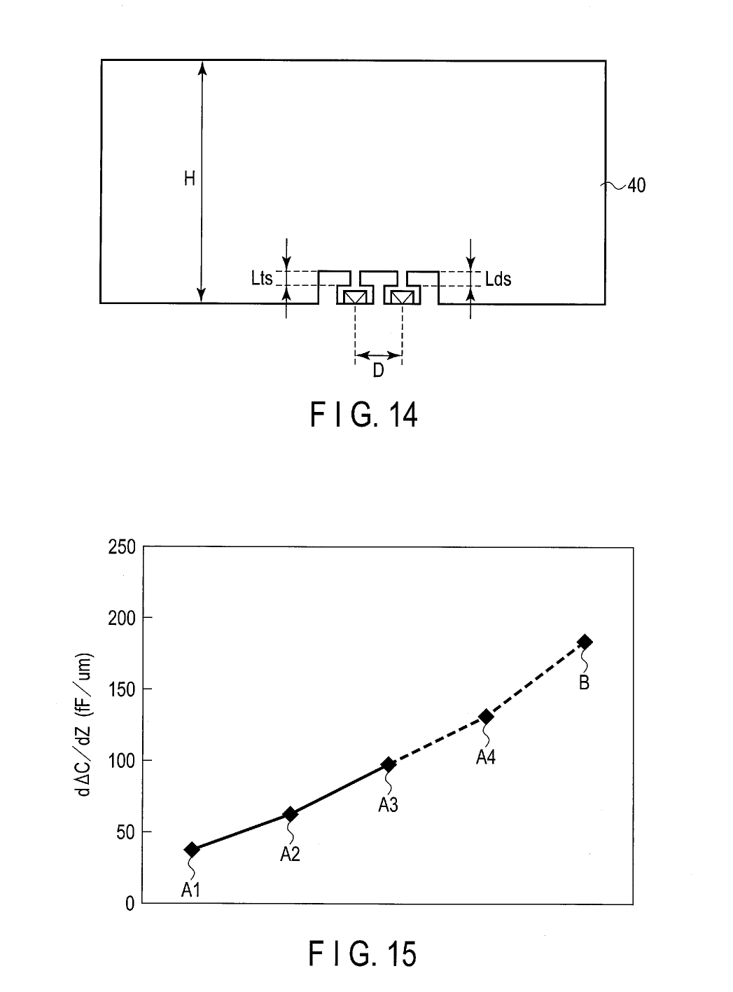

FIG. 14 shows dimensions of members to obtain a value of dΔC/dZ. FIG. 15 is a graph showing the value of dΔC/dZ set when the dimensions of the members are varied. In FIG. 15, types A1, A2, A3, and A4 indicate values of dΔC/dZ in a case where the fixed portions 62 are provided in the area outside the top electrode 40 as shown in FIG. 12. In FIG. 15, type B indicates a value of dΔC/dZ in a case where the fixed portion 62 is provided to be close to the fixed portion 72 in the area surrounded by the top electrode 40 as shown in FIG. 13. The dimensions of the members of types A1, A2, A3, and A4 and type B are as follows.

### Type A1 H=150 μm, Lts=25 μm, Lds=20 μm

### Type A2 H=100 μm, Lts=25 μm, Lds=20 μm

### Type A3 H=50 μm, Lts=25 μm, Lds=20 μm

### Type A4 H=50 μm, Lts=10 μm, Lds=10 μm

### Type B H=200 μm, Lts=10 μm, Lds=10 μm

The value of dΔC/dZ can be increased by adopting the configuration of the present modified example shown in FIG. 13, which can be understood from FIG. 15. This is because the deformation of the top electrode 40 can be suppressed as compared with the basic configuration example shown in FIG. 12, in the configuration of the present modified example.

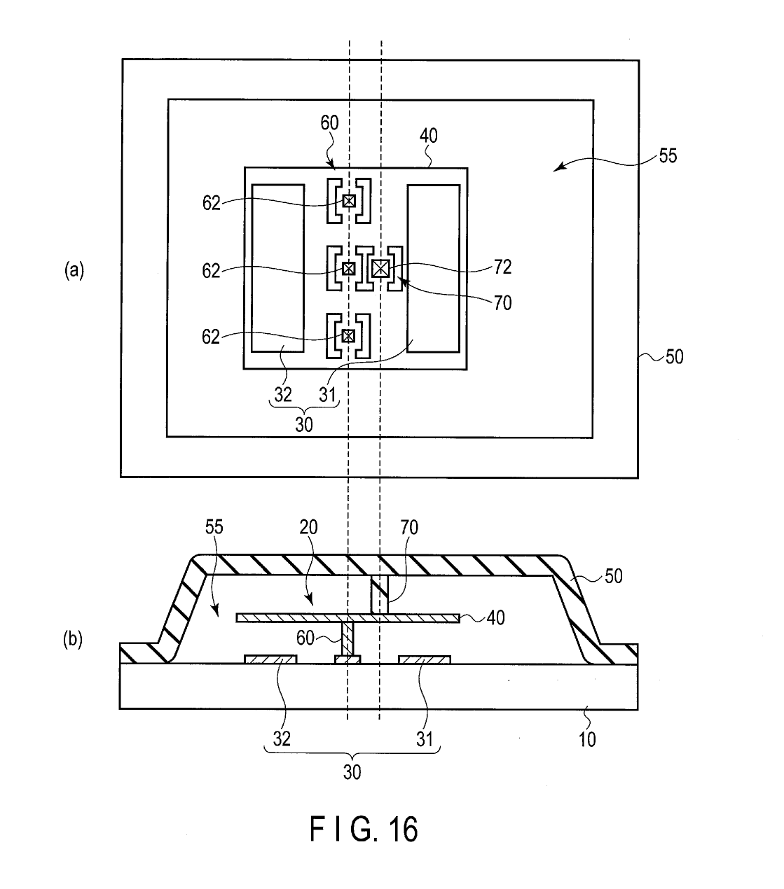

FIG. 16 pictorially shows a configuration of a second modified example of the sensor (pressure sensor) of the present embodiment. In the present modified example, the fixed portions 62 of the support structure 60 are provided in three areas surrounded by the top electrode 40, respectively. By adopting this configuration, the top electrode 40 can be supported more strongly and damage from an impulse can be suppressed.

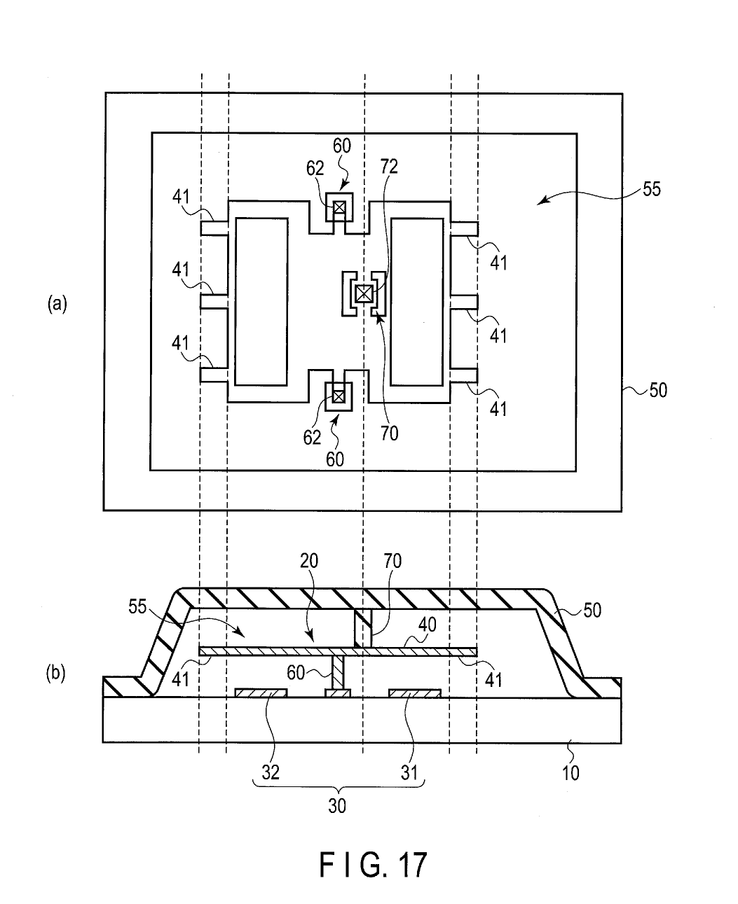

FIG. 17 pictorially shows a configuration of a third modified example of the sensor (pressure sensor) of the present embodiment. In the present modified example, bumper members 41 are provided at a peripheral portion of the top electrode 40.

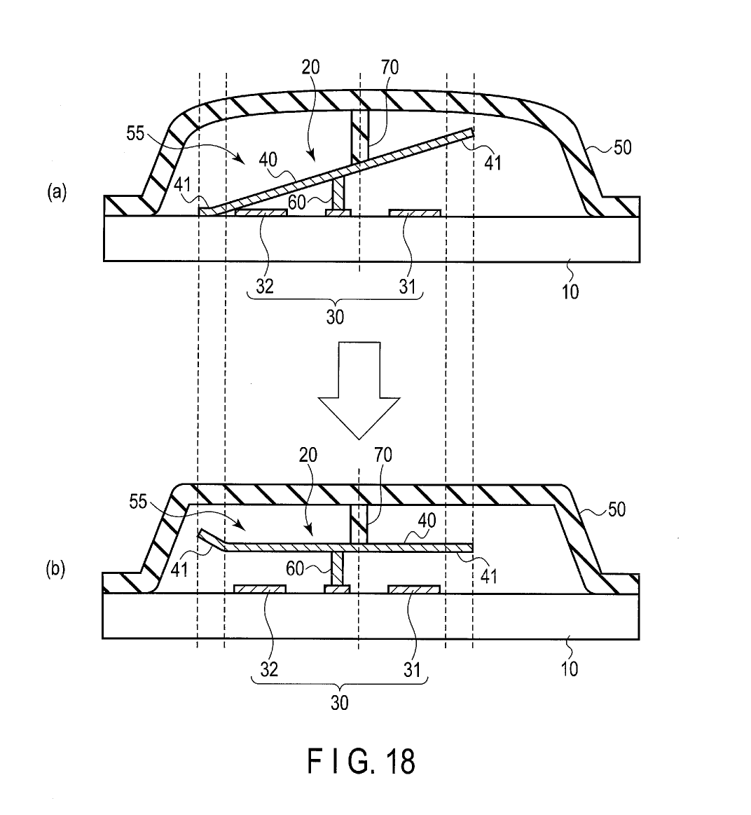

FIG. 18 shows an effect of the present modified example. For example, if the thin-film structure 50 is abruptly expanded outwardly by impulse, reduction in external pressure or the like, the bumper members 41 are brought into contact with the substrate 10 instead of the top electrode 40, as shown in FIG. 18(a). Consequently, deformation of the top electrode 40 can be prevented by the deformation of the bumper members 41 as shown in FIG. 18(b). The same effect can also be obtained when the thin-film structure 50 is abruptly concaved inwardly by impulse, increase in external pressure or the like.

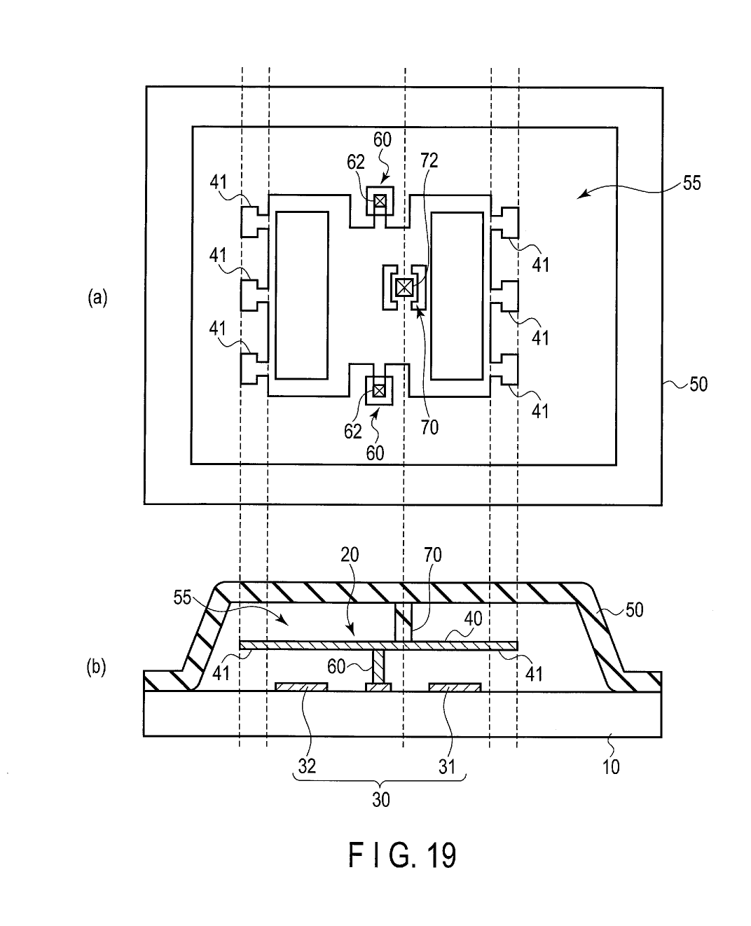

FIG. 19 pictorially shows a configuration of a fourth modified example of the sensor (pressure sensor) of the present embodiment. In the present modified example, too, the bumper members 41 are provided at the peripheral portion of the top electrode 40. In the present modified example, a constriction is formed at each of the bumper members 41. Deformed portions can be controlled and the shape tolerance can be suppressed by thus forming the constrictions at the bumper members 41.

### Embodiment 2

Next, a sensor of a second embodiment will be explained. The sensor of the present embodiment is also used as a pressure sensor and is formed with the technology of MEMS. Since basic elements are the same as those of the first embodiment, the descriptions of the elements explained in the first embodiment are omitted.

In the sensor (pressure sensor) of the present embodiment, a reference capacitor is provided besides the variable capacitor explained in the first embodiment.

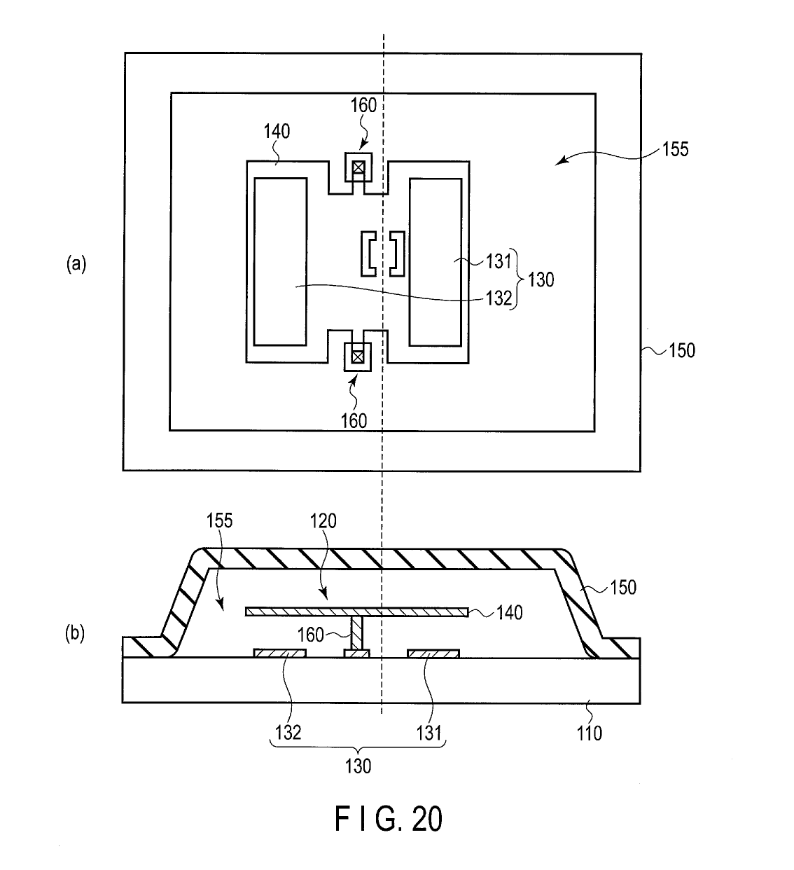

FIG. 20 pictorially shows a first configuration example of the sensor (pressure sensor) of the present embodiment. FIG. 20(a) is a plan view and FIG. 20(b) is a cross-sectional view.

The sensor (pressure sensor) shown in FIG. 20 comprises a substrate 110, a reference capacitor 120 including a bottom electrode 130 and a top electrode 140, a thin-film structure (movable structure) 150, and a support structure 160.

The substrate 110 is common to the substrate 10 of the first embodiment. The reference capacitor 120 is formed on the same substrate (10, 110) as the variable capacitor 20 of the first embodiment. The reference capacitor 120 (i.e., the bottom electrode 130 and the top electrode 140), the thin-film structure 150 and the support structure 160 are formed in the same process as the variable capacitor 20 (i.e., the bottom electrode 30 and the top electrode 40), the thin-film structure 50 and the support structure 60 of the first embodiment, respectively. A cavity 155 is formed inside the thin-film structure 150. In the present configuration example, a structure corresponding to the connection structure 70 of the first embodiment is not provided.

The area of a first electrode portion 131 of the bottom electrode 130 corresponds to the area of the first electrode portion 31 of the bottom electrode 30 of the first embodiment, and the area of a second electrode portion 132 of the bottom electrode 130 corresponds to the area of the second electrode portion 32 of the bottom electrode 30 of the first embodiment. In addition, the area of the top electrode 140 corresponds to the area of the top electrode 40 of the first embodiment. Furthermore, a distance (interval) between the bottom electrode 130 and the top electrode 140 corresponds to a distance (interval) between the bottom electrode 30 and the top electrode 40 in a steady state in which the top electrode 40 is not displaced, of the first embodiment. A first capacitance of a first capacitor composed of the first electrode portion 131 and the top electrode 140 corresponds to the first capacitance in the steady state, of the first capacitor of the first embodiment. Similarly to this, a second capacitance of a second capacitor composed of the second electrode portion 132 and the top electrode 140 corresponds to the second capacitance in the steady state, of the second capacitor of the first embodiment.

In the present embodiment, the reference capacitor 120 is thus provided besides the variable capacitor 20 explained in the first embodiment. By adopting this configuration, an influence of the manufacturing tolerance or an influence of aging change, which results from the variation in temperature and the like, can be canceled by the reference capacitor 120, and a sensor having a high detection accuracy can be obtained.

In addition, an influence of variation of the distance (interval) between the top electrode 40 and the thin-film structure 50 in the variable capacitor can be reduced by adopting the first configuration example.

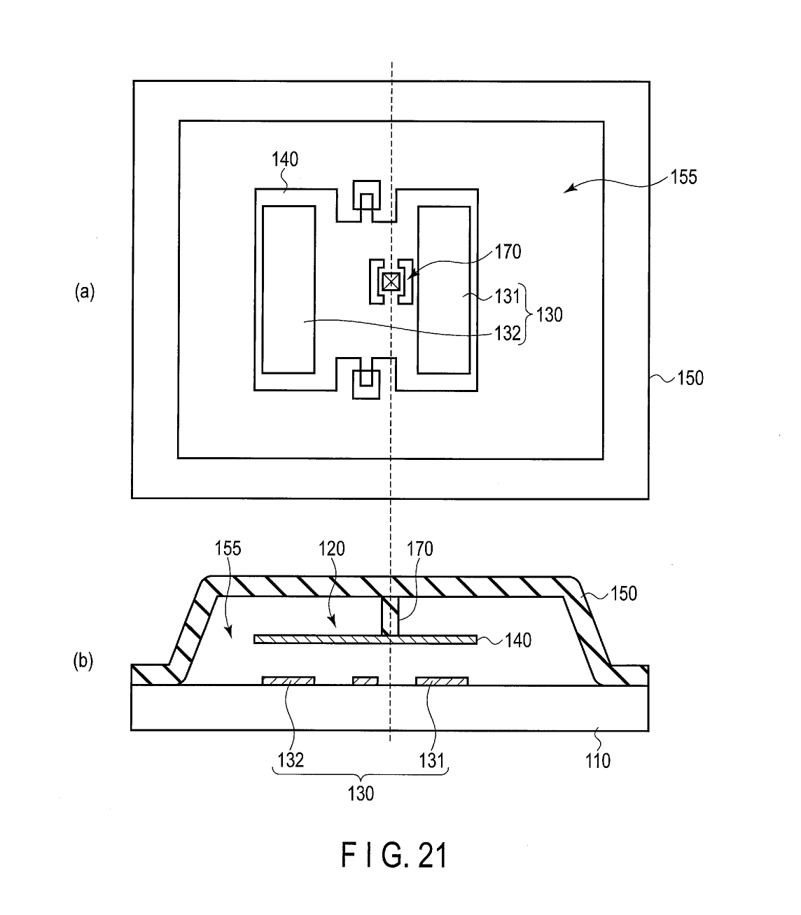

FIG. 21 pictorially shows a configuration of a second configuration example of the sensor (pressure sensor) of the present embodiment. In the present configuration example, a connection structure 170 is provided but a structure corresponding to the support structure 60 of the first embodiment is not provided. The connection structure 170 is formed in the same process as the connection structure 70 of the first embodiment.

If the present configuration example is employed, various influences can be canceled by the reference capacitor 120, and a sensor having a high detection accuracy can be obtained, similarly to the first configuration example.

In addition, an influence of variation of the distance (interval) between the top electrode 40 and the substrate 10 in the variable capacitor can be reduced by adopting the configuration of the present configuration example.

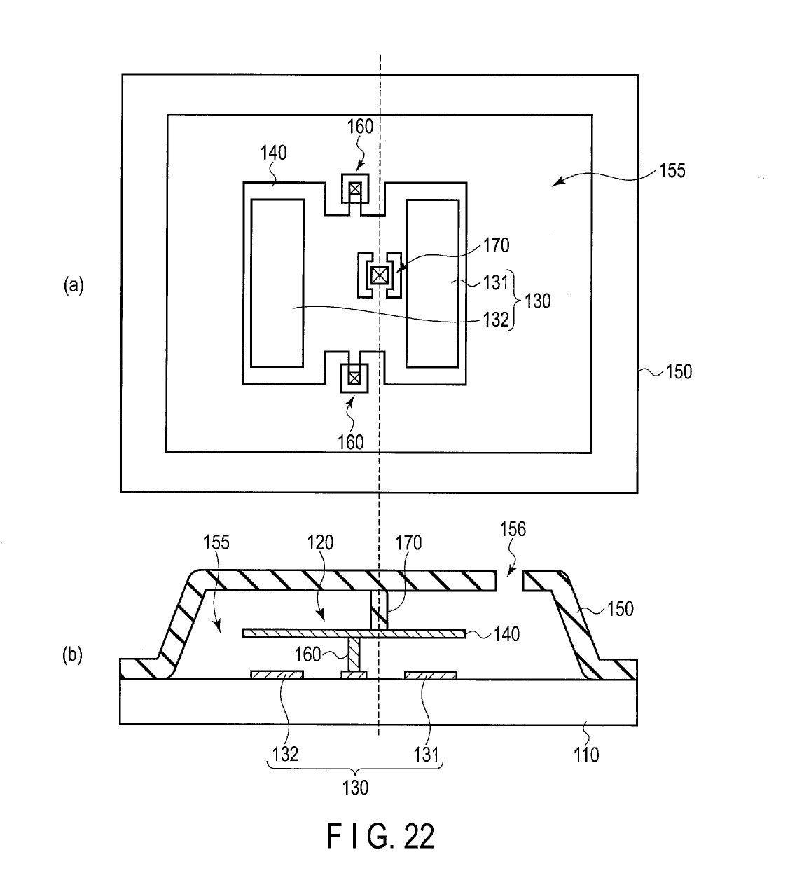

FIG. 22 pictorially shows a configuration of a third configuration example of the sensor (pressure sensor) of the present embodiment. In the present configuration example, both the support structure 160 and the connection structure 170 are provided. In addition, a hole 156 is formed in the thin-film structure 150 in the present configuration example.

If the present configuration example is employed, various influences can be canceled by the reference capacitor 120, and a sensor having a high detection accuracy can be obtained, similarly to the first configuration example.

Since the internal pressure and the external pressure of the thin-film structure 150 can be made to equivalent to each other by adopting the configuration of the present configuration example, the configuration of the present structure can be used as a reference of an effective spring constant of the thin-film structure 50.

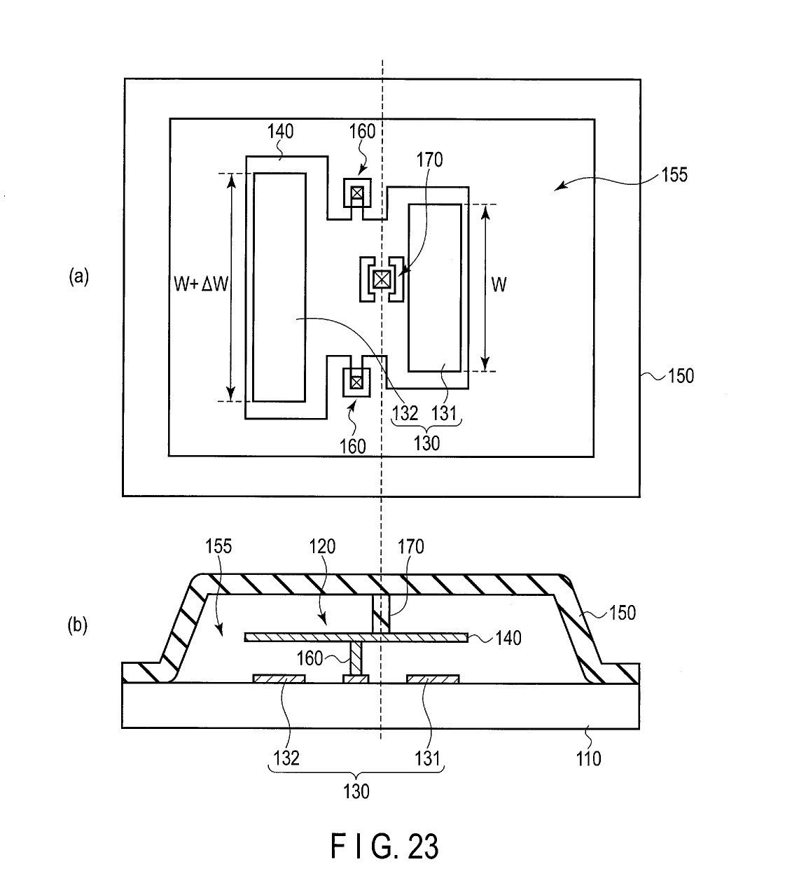

FIG. 23 pictorially shows a configuration of a fourth configuration example of the sensor (pressure sensor) of the present embodiment. In the present configuration example, the area of the first reference capacitor composed of the first electrode portion 131 and the top electrode 140 is smaller than the area of the second reference capacitor composed of the second electrode portion 132 and the top electrode 140. More specifically, an electrode width of the first electrode portion 131 is represented by W and an electrode width of the second electrode portion 132 is represented by W+ΔW. If this configuration is adopted, the first capacitance C₊(4z) of the first reference capacitor and the second capacitance C₋(Δz) of the second reference capacitor become as follows.

ΔC=C₊(Δz)−C₋(Δz)=εΔW(L2−L1)/g0+2C_{L}r_{L}(Δz/g0)+O(a²) (1)

If the present configuration example is employed, various influences can be canceled by the reference capacitor 120, and a sensor having a high detection accuracy can be obtained, similarly to the first configuration example.

In addition, an influence of variation of the distance (interval) between the top electrode 40 and the substrate 10 in the variable capacitor 20, and an influence of the effective spring constant of the thin-film structure 50 can be reduced by adopting the configuration of the present configuration example.

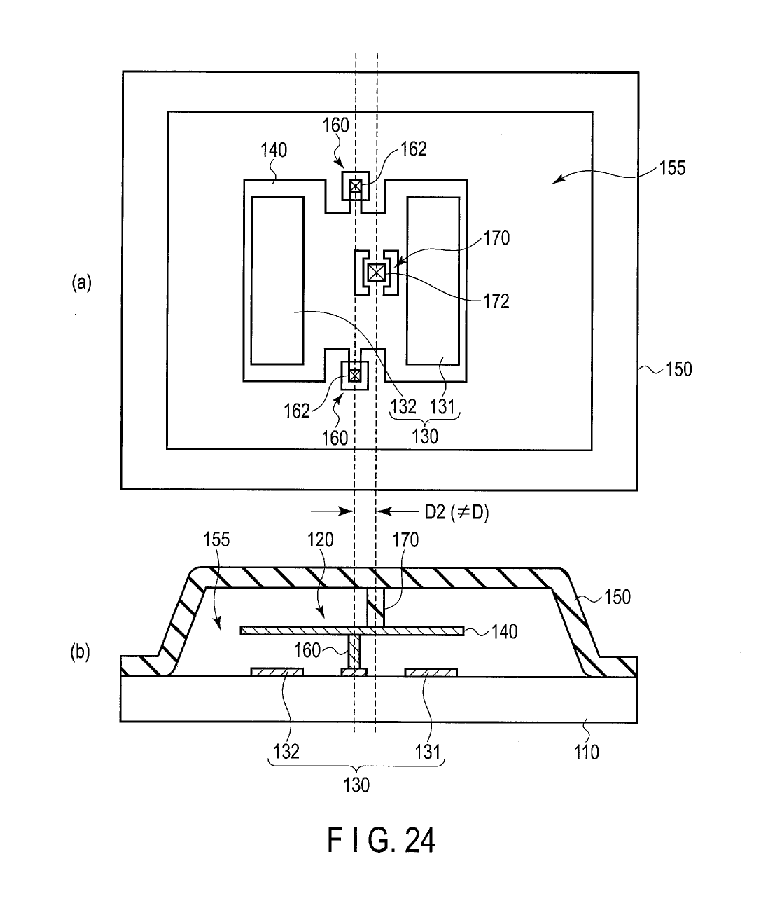

FIG. 24 pictorially shows a configuration of a fifth configuration example of the sensor (pressure sensor) of the present embodiment. In the present configuration example, a distance D2 between fixed portions 162 of the support structures 160 and a fixed portion 172 of the connection structure 170 is made different from the distance D between the fixed portions 62 of the support structures 60 and the fixed portion 72 of the connection structure 70 in the first embodiment. It should be noted that values of L1, L2 or g may be different in the variable capacitor in the first embodiment and the reference capacitor in the present embodiment.

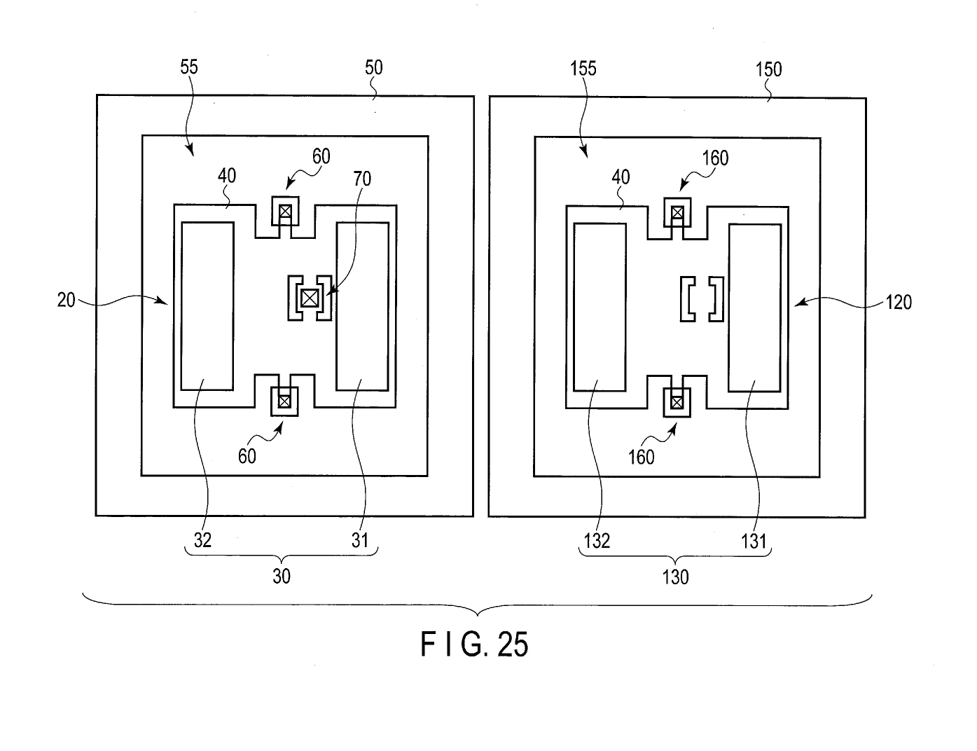

FIG. 25 pictorially shows a configuration of a sixth configuration example of the sensor (pressure sensor) of the present embodiment. In the present configuration example, the thin-film structure 50 is provided above the variable capacitor 20, and another thin-film structure 150 is provided above the reference capacitor 120. In other words, in the present configuration example, the variable capacitor 20 and the reference capacitor 120 are provided independently of each other.

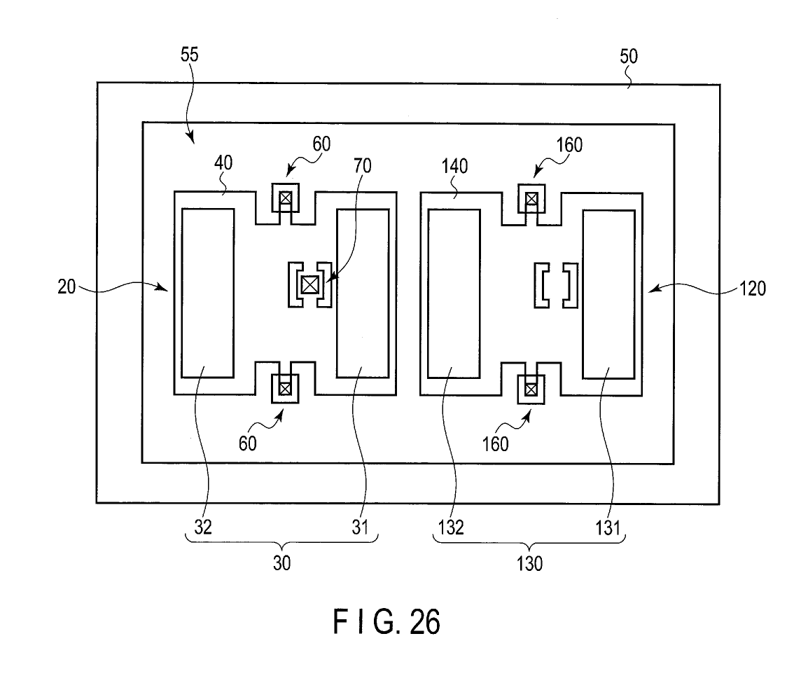

FIG. 26 pictorially shows a configuration of a seventh configuration example of the sensor (pressure sensor) of the present embodiment. In the present configuration example, the thin-film structure 50 is provided above the variable capacitance 20, and the common thin-film structure 50 is also provided above the reference capacitor 120. In other words, in the present configuration example, the thin-film structure 50 further includes a portion located above the top electrode 40 of the variable capacitor 20, and a portion located above the top electrode 140 of the reference capacitor 120.

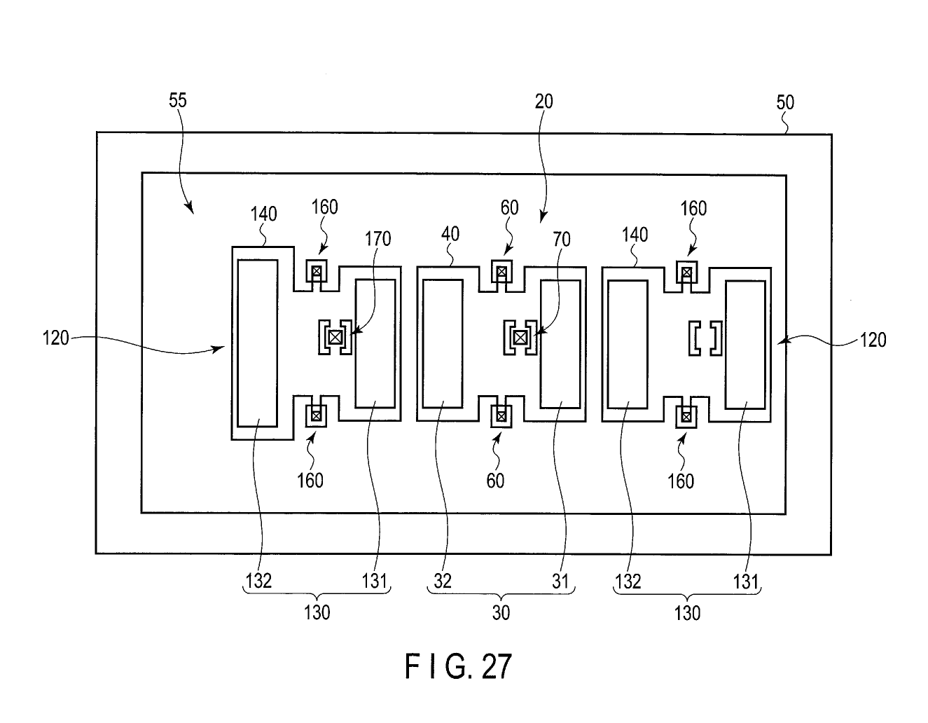

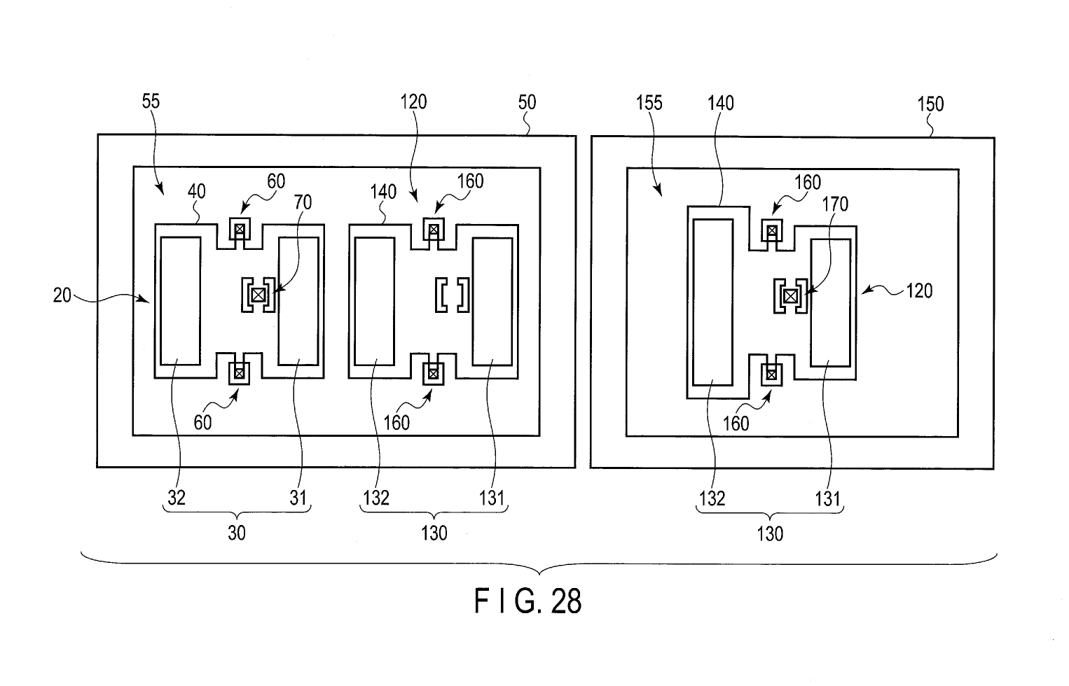

FIG. 27 pictorially shows a configuration of an eighth configuration example of the sensor (pressure sensor) of the present embodiment. The present configuration example is an extended configuration of the seventh configuration example shown in FIG. 26. In the present configuration example, the thin-film structure 50 is provided above the variable capacitor 20, and the common thin-film structure 50 is also provided above the reference capacitors 120.

FIG. 28 pictorially shows a configuration of a ninth configuration example of the sensor (pressure sensor) of the present embodiment. The present configuration example is a combination of the sixth configuration example shown in FIG. 25 and the seventh configuration example shown in FIG. 26. In the present configuration example, the thin-film structure 50 is provided above the variable capacitor 20, the common thin-film structure 50 is also provided above the reference capacitor 120, and another thin-film structure 150 is provided above another reference capacitor 120.

Next, a method of removing variation factors in the variable capacitor by using the reference capacitor will be explained.

The area of the thin-film structure is represented by Sd and the effective spring constant of the thin-film structure is represented by k. The central portion of the thin-film structure is assumed to be displaced by Δz when the pressure is varied from p to p+Δp. In this case, a relational expression kΔz=SdΔp is established. Therefore,

ΔC=Δp×Q1×Q2

Q1=çSdW(L2²−L1²)/D

Q2=1/g0²k

Δp represents a physical amount to be obtained. Q1 represents an amount which includes little variation and can be controlled by design. Q2 represents an amount which includes comparatively large process variation. The object of the reference capacitor is to delete Q2 and extract Δp.

If the reference capacitor having no influence of pressure variation as shown in FIG. 20 or FIG. 22 is used,

ΔC′=p0×Q1×Q2

in the reference capacitor. Therefore, if p0 is recognized in the test process, Q2 can be deleted from the expression

ΔC/ΔC′=Δp/p0.

If the reference capacitor having the influence of pressure variation is used and if the relationship of Expression 1 is established, contribution of the reference capacitor is

ΔC″=(Δp+P1)×Q1×Q2.

Therefore, in this case, too, Q2 can be deleted from expression ΔC/ΔC″=Δp/(Δp+p1).

As explained above, various influences can be canceled by the reference capacitor and a sensor having a high detection accuracy can be obtained, by using the reference capacitor.

### Embodiment 3

Next, a sensor of a third embodiment will be explained. The sensor of the present embodiment is also used as a pressure sensor and is formed with the technology of MEMS. Since basic elements are the same as those of the first embodiment, the descriptions of the elements explained in the first embodiment are omitted.

The present embodiment relates to positions of constituent elements of the sensor (pressure sensor).

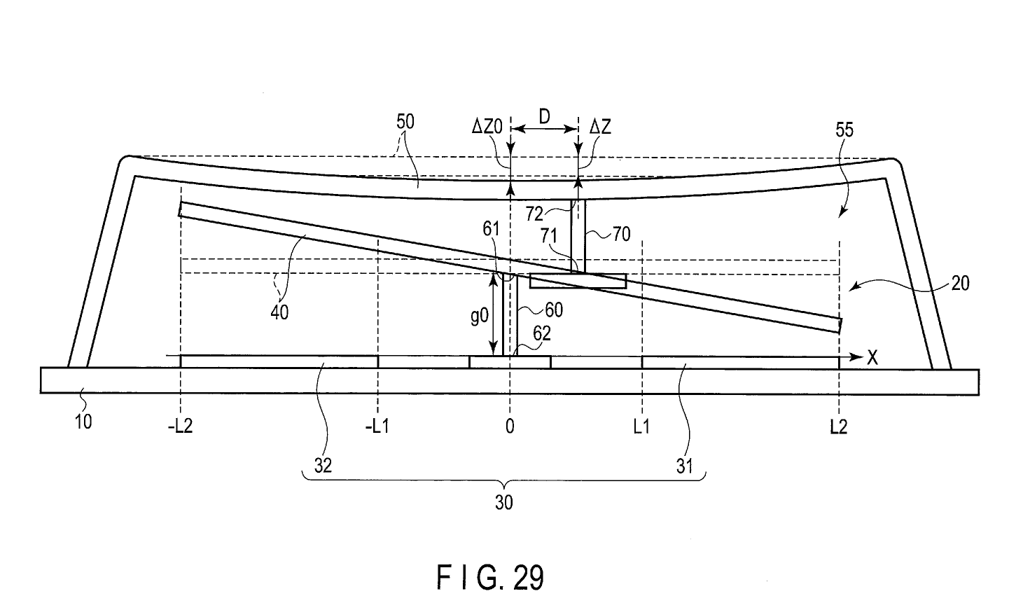

FIG. 29 pictorially shows a first configuration example of the sensor (pressure sensor) of the present embodiment.

In the first embodiment, as shown in FIG. 1, the axis penetrating the at least one support portion 61 (i.e., the rotation axis perpendicular to the surface of a sheet of drawing) penetrates a central portion of the top electrode 40 as viewed from the direction perpendicular to the main surface of the top electrode 40. The fixed portion 72 of the connection structure 70 is fixed at the central portion of the movable structure (thin-film structure) 50. For this reason, in the first embodiment, the axis penetrating the at least one support portion 61 penetrates a position displaced from the central portion of the movable structure (thin-film structure) 50 as viewed from the direction perpendicular to the main surface of the top electrode 40. In the first embodiment, as shown in FIG. 1, the variable capacitor 20 is therefore displaced to either side of the movable structure (thin-film structure) 50.

In the present embodiment, too, the axis penetrating the at least one support portion 61 (i.e., the rotation axis perpendicular to the surface of a sheet of drawing) penetrates a central portion of the top electrode 40 as viewed from the direction perpendicular to the main surface of the top electrode 40, similarly to the first embodiment. In the present embodiment, however, the fixed portion 72 of the connection structure 70 is fixed at a position displaced from the central portion of the movable structure (thin-film structure) 50. Then, the axis penetrating the at least one support portion 61 penetrates the central portion of the movable structure (thin-film structure) 50 as viewed from the direction perpendicular to the main surface of the top electrode 40. In the present embodiment, as shown in FIG. 29, the variable capacitor 20 is therefore arranged around the central portion of the movable structure (thin-film structure) 50.

Therefore, the space in the movable structure (thin-film structure) 50 can be used to the maximum limited and the dead spots in the movable structure (thin-film structure) 50 can be reduced, in the present configuration example.

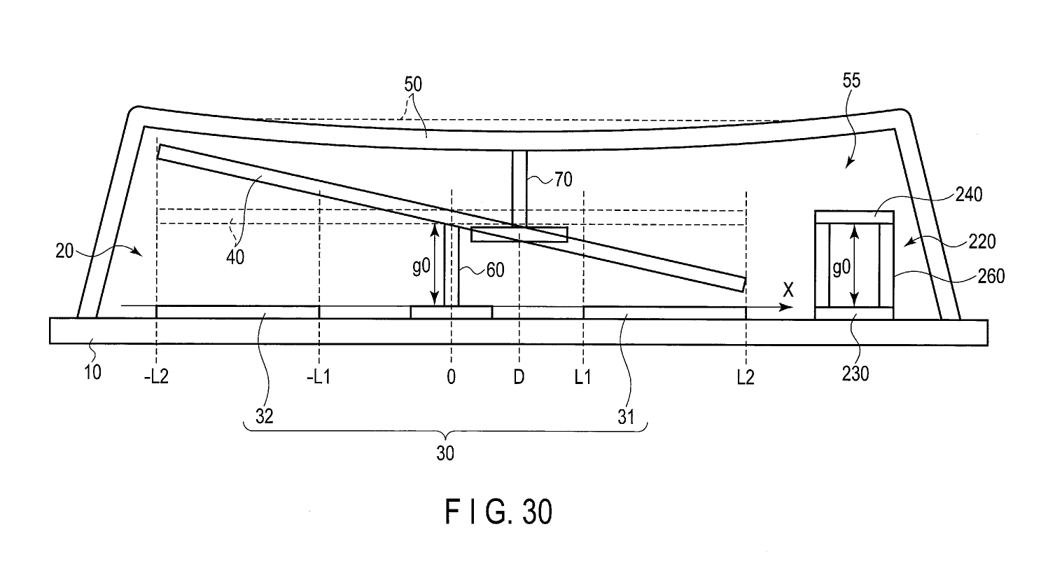

FIG. 30 pictorially shows a second configuration example of the sensor (pressure sensor) of the present embodiment. In the present configuration example, a positional relationship among the bottom electrode 30, the top electrode 40, the movable structure (thin-film structure) 50, the support structure 60, and the connection structure 70 is the same as that of the first embodiment shown in FIG. 1. The reference capacitor 220 comprising the bottom electrode 230, the top electrode 240 and the support structure 260 is provided in a dead spot of the area in the movable structure (thin-film structure) 50, in the present configuration example. The variation in initial gap g0 can be monitored and corrected in this configuration.

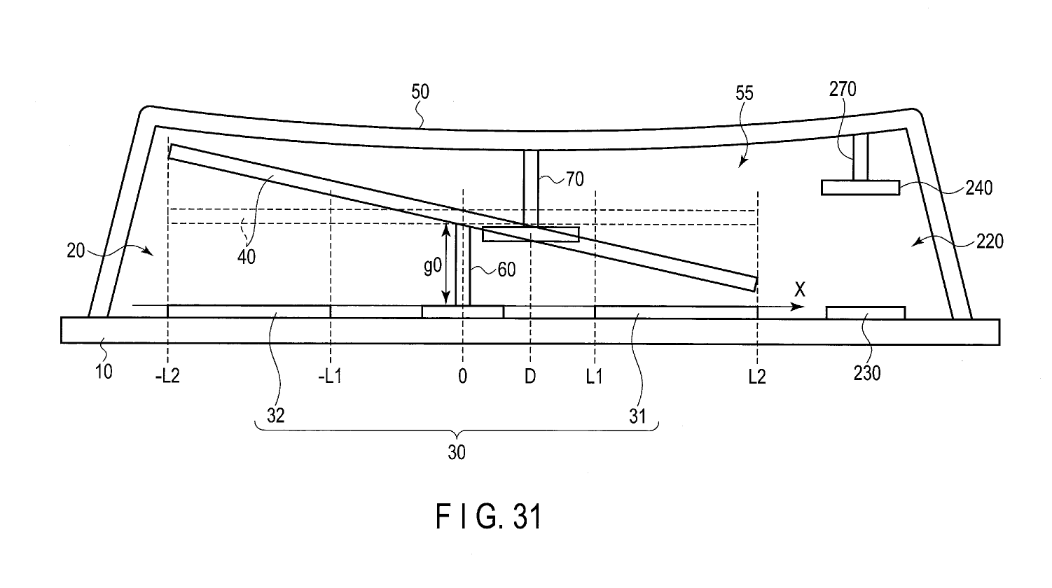

FIG. 31 pictorially shows a third configuration example of the sensor (pressure sensor) of the present embodiment. In the present configuration example, too, a positional relationship among the bottom electrode 30, the top electrode 40, the movable structure (thin-film structure) 50, the support structure 60, and the connection structure 70 is the same as that of the first embodiment shown in FIG. 1. The reference capacitor 220 comprising the bottom electrode 230, the top electrode 240 and a connection structure 270 is provided in a dead spot of the area in the movable structure (thin-film structure) 50, in the present configuration example. The variation in height of the movable structure (thin-film structure) 50, which results from the manufacturing variation, variation in temperature or the like, can be monitored and corrected in this configuration.

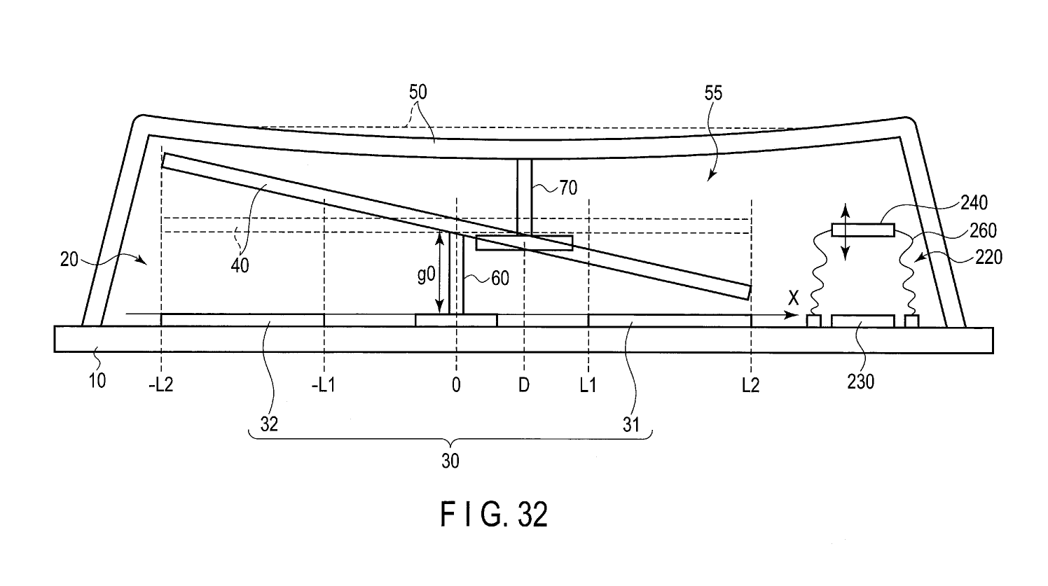

FIG. 32 pictorially shows a fourth configuration example of the sensor (pressure sensor) of the present embodiment. In the present configuration example, too, a positional relationship among the bottom electrode 30, the top electrode 40, the movable structure (thin-film structure) 50, the support structure 60, and the connection structure 70 is the same as that of the first embodiment shown in FIG. 1. The reference capacitor 220 comprising the bottom electrode 230, the top electrode 240 and the support structure 260 is provided in a dead spot of the area in the movable structure (thin-film structure) 50, in the present configuration example. In the present configuration example, the support structure 260 is composed of a spring formed of SiN or Al. The internal pressure which is to be used for measurement of mechanical Q value can be monitored in this configuration.

### Embodiment 4

Next, a sensor of a fourth embodiment will be explained. The sensor of the present embodiment is also used as a pressure sensor and is formed with the technology of MEMS. Since basic elements are the same as those of the first embodiment, the descriptions of the elements explained in the first embodiment are omitted.

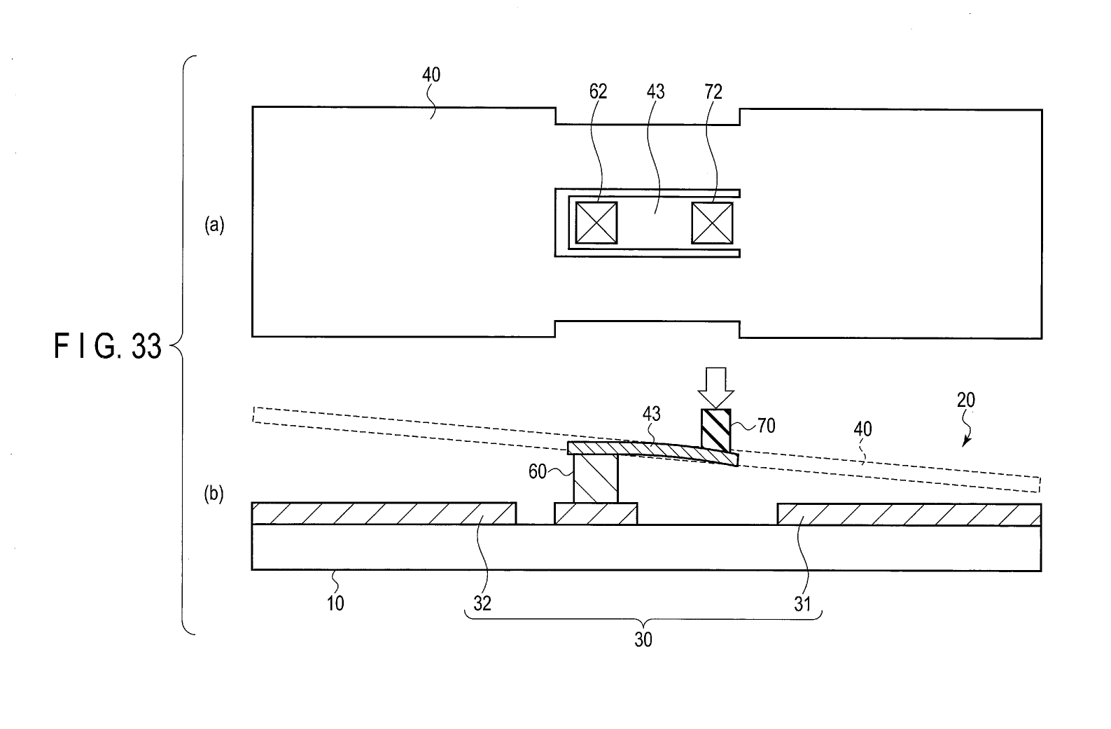

FIG. 33 pictorially shows a first configuration example of the sensor (pressure sensor) of the present embodiment. FIG. 33(a) is a plan view and FIG. 33(b) is a cross-sectional view. A movable structure (thin-film structure) 50 is not shown for the purpose of simplifying the explanations.

The torsion bar members 63 and the torsion bar members 73 are provided at the support structure 60 and the connection structure 70 in the first embodiment, but the torsion bar members are not provided in the present embodiment. In the present configuration example, a protruding member 43 is provided inside a top electrode 40, and a fixing member 62 of the support structure 60 and a fixing member 72 of the connection structure 70 are connected to the protruding member 43. In the present configuration example having such a configuration, a top electrode 40 and the protruding member 43 can be formed of the same material in the same process, and the manufacturing process can be simplified.

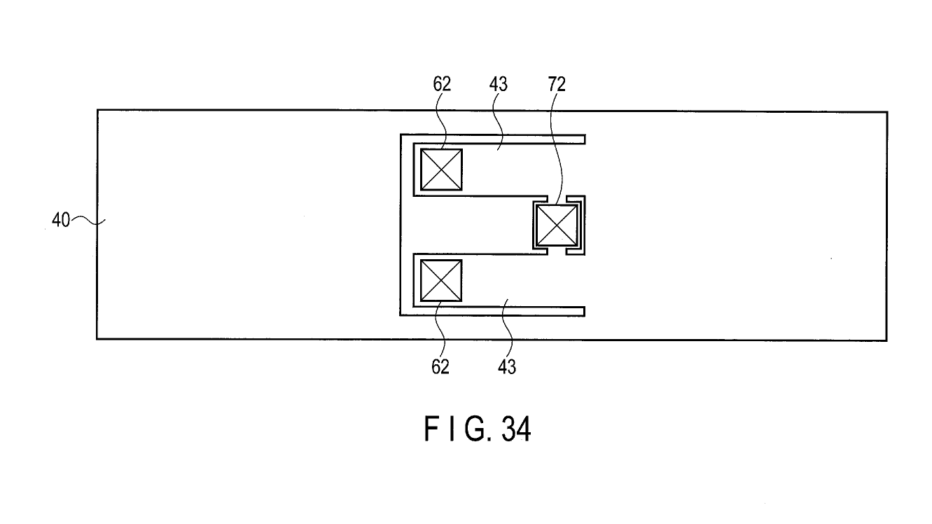

FIG. 34 is a plan view pictorially showing a second configuration example of the sensor (pressure sensor) of the present embodiment. The basic configuration is the same as the first configuration example. In the present configuration example, two protruding members 43 are provided inside a top electrode 40, and fixing members 62 are connected to the respective protruding members 43. In addition, a fixing member 72 is arranged in an area connected to the protruding members 43. The same advantage as that of the first configuration example can be obtained in the present configuration, too.

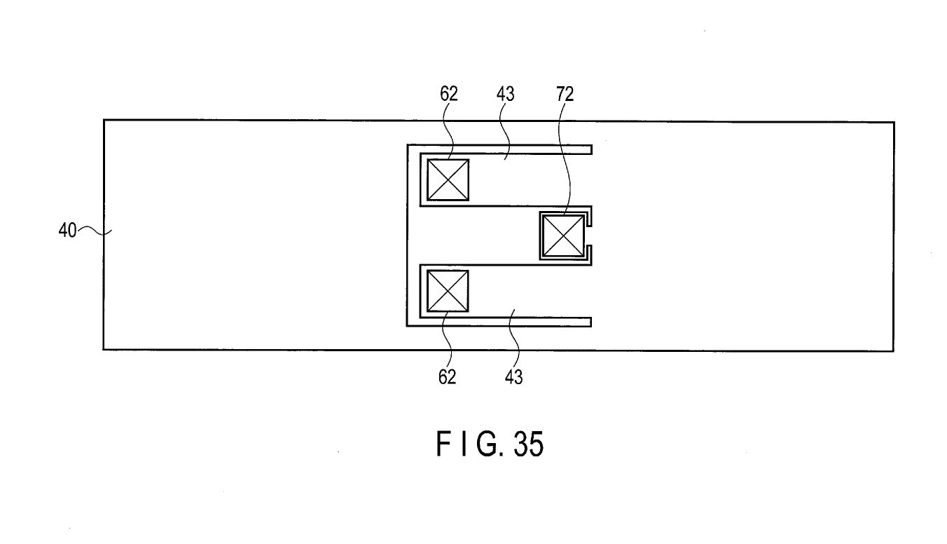

FIG. 35 is a plan view pictorially showing a third configuration example of the sensor (pressure sensor) of the present embodiment. The basic configuration is the same as the first configuration example. In the present configuration example, too, two protruding members 43 are provided inside the top electrode 40, and the fixing members 62 are connected to the respective protruding members 43. In addition, the fixing member 72 is arranged in an area connected to the main body of the top electrode 40. The same advantage as that of the first configuration example can be obtained in the present configuration, too.

As explained above, the sensor (pressure sensor) of the first to fourth embodiments uses the variable capacitor 20 using the principle of leverage. For this reason, the displacement of the top electrode 40 based on the displacement of the movable structure (thin-film structure) 50 can be increased. Thus, the sensitivity of detection can be increased, and a sensor having a high detection accuracy can be obtained.

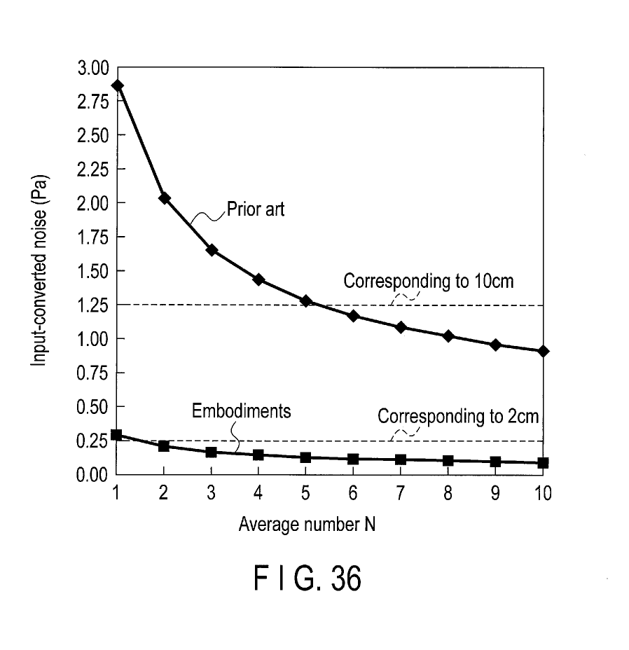

FIG. 36 is a graph showing the above-explained advantage. By using the pressure sensor of the embodiments, noise can be remarkably reduced as compared with the conventional pressure sensor of simply moving up and down the top electrode (movable electrode) with respect to the bottom electrode (fixed electrode). Consequently, resolution of 2 cm or less can be obtained if the pressure sensor of the embodiment is used as an altimeter.

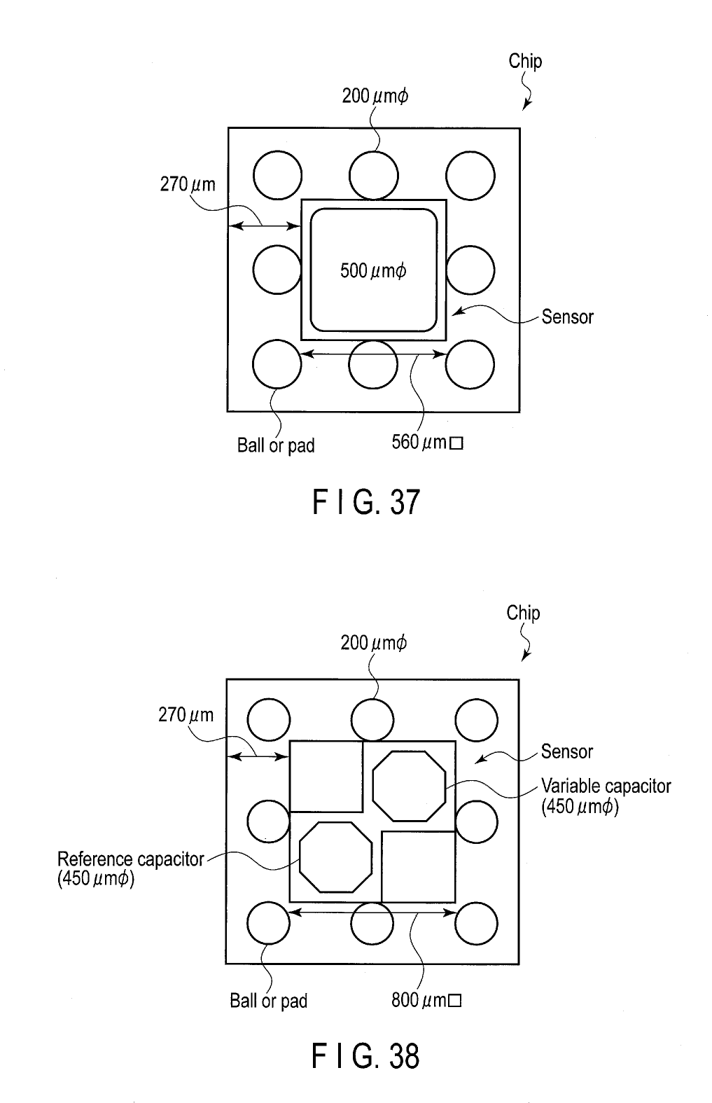

FIG. 37 and FIG. 38 pictorially show a configuration example in which the sensor (pressure sensor) of the first to fourth embodiments is disposed in a chip. FIG. 37 shows a configuration example in which a reference capacitor is not provided, and FIG. 38 shows a configuration example in which a reference capacitor is provided.

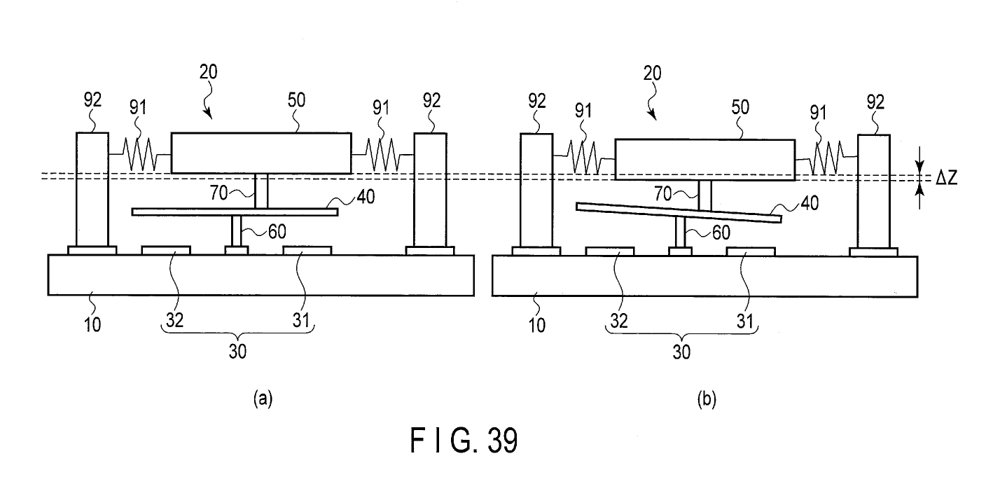

FIG. 39 pictorially shows a configuration example of an accelerometer using the same principle as the sensor (pressure sensor) of the first to fourth embodiments. FIG. 39(a) shows a steady state and FIG. 39(b) shows a state in which the acceleration is applied.

The sensor (accelerometer) shown in FIG. 39 also comprises a substrate 10, a variable capacitor 20 including a bottom electrode 30 and a top electrode 40, a movable structure 50, a support structure 60, and a connection structure 70, similarly to the sensors of the first to fourth embodiments. In the present configuration example, the movable structure 50 functions as a mass structure. The movable structure (mass structure) 50 is connected to wall members 92 via springs 91.

If the acceleration (specific physical quantity) is applied to the sensor, the movable structure (mass structure) 50 is displaced and then the top electrode 40 is displaced via the connection structure 70. Consequently, the differential capacitance can be obtained on the same principle as the principle explained in the first embodiment. The acceleration can be detected based on the differential capacitance.

Thus, when the sensor is used as the accelerometer, a sensor having a high detection accuracy can also be obtained by constituting the variable capacitor 20 utilizing the principle of leverage.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sensor comprising:
a substrate;
a variable capacitor including a bottom electrode provided on the substrate and a top electrode provided above the bottom electrode so as to face the bottom electrode;
a movable structure including a portion located above the top electrode and being movable in accordance with a specific physical quantity;
a support structure including at least one support portion supporting the top electrode; and
a connection structure connecting the movable structure and the top electrode to displace the top electrode based on displacement of the movable structure,
wherein the top electrode is displaced about an axis penetrating the at least one support portion, which serves as a first rotation axis.

2. The sensor of claim 1, wherein
the support structure further includes at least one fixed portion fixed to the substrate.

3. The sensor of claim 2, wherein
the support structure further includes at least one torsion bar member provided between the at least one support portion and the at least one fixed portion.

4. The sensor of claim 3, wherein
the at least one torsion bar member is formed of a material different from a material of the top electrode.

5. The sensor of claim 3, wherein
the at least one torsion bar member is formed of a same material as a material of the top electrode.

6. The sensor of claim 3, wherein
the at least one torsion bar member is formed of a material selected from SiN, SiO, AlO, TiAl, Si and SiGe.

7. The sensor of claim 1, wherein
the axis penetrating the at least one support portion penetrates a central portion of the top electrode as viewed from a direction perpendicular to a main surface of the top electrode.

8. The sensor of claim 1, wherein
the axis penetrating the at least one support portion penetrates a central portion of the movable structure as viewed from a direction perpendicular to a main surface of the top electrode.

9. The sensor of claim 1, wherein
the connection structure includes at least one connection portion connected to the top electrode, and the at least one connection portion is displaced from the at least one support portion as viewed from a direction perpendicular to a main surface of the top electrode.

10. The sensor of claim 9, wherein
the connection structure further includes a fixed portion fixed to the movable structure.

11. The sensor of claim 10, wherein
the fixed portion is fixed to a central portion of the movable structure.

12. The sensor of claim 10, wherein
the connection structure further includes at least one torsion bar member provided between the fixed portion and the at least one connection portion.

13. The sensor of claim 12, wherein
the first rotation axis and a second rotation axis penetrating the at least one torsion bar member are parallel to each other.

14. The sensor of claim 1, wherein
the bottom electrode includes a first electrode portion and a second electrode portion electrically insulated from each other.

15. The sensor of claim 14, wherein
a first capacitor having a first capacitance is formed by the top electrode and the first electrode portion, and a second capacitor having a second capacitance is formed by the top electrode and the second electrode portion, and
when the top electrode is displaced, one of the first capacitance and the second capacitance increases while the other of the first capacitance and the second capacitance decreases.

16. The sensor of claim 15, wherein
the first electrode portion and the second electrode portion are provided to obtain a differential capacitance between the first capacitance and the second capacitance.

17. The sensor of claim 15, wherein
the connection structure is provided between the support structure and either of the first capacitor and the second capacitor.

18. The sensor of claim 1, wherein
the movable structure covers and hermetically seals the variable capacitor.

19. The sensor of claim 1, wherein
the specific physical quantity is a pressure applied to the movable structure.

20. The sensor of claim 1, further comprising:
a bumper member provided in a peripheral portion of the top electrode.

21. The sensor of claim 1, further comprising:
a reference capacitor including a second bottom electrode provided on the substrate and a second top electrode provided above the second bottom electrode so as to face the second bottom electrode.

22. The sensor of claim 21, further comprising:
a second movable structure including a portion located above the second top electrode and being movable in accordance with the specific physical quantity.

23. The sensor of claim 21, wherein
the movable structure further includes a portion located above the second top electrode.
